(19) United States
(12) Patent Application Publication
(10) Pub. No.: US 2025/0329125 A1
(43) Pub. Date: Oct. 23, 2025

(54) Pose Editing Techniques for Virtual Characters

(71) Applicant: Tencent Technology (Shenzhen) Company Limited, Shenzhen (CN)

(72) Inventors: Yingting Zhu, Shenzhen (CN); Liang Kang, Shenzhen (CN); Danxing Xu, Shenzhen (CN)

(21) Appl. No.: 19/254,432

(22) Filed: Jun. 30, 2025

Related U.S. Application Data
(63) Continuation of application No. PCT/CN2024/087699, filed on Apr. 15, 2024.

(30) Foreign Application Priority Data
Jun. 21, 2023 (CN) 2023107476874

(51) Int. Cl. G06T 19/20

(52) U.S. Cl. CPC G06T 19/20; G06T 2219/2016

(57) ABSTRACT

This application describes pose editing techniques for a virtual character, and is applied to the field of three-dimensional virtual environments. The described techniques may include displaying a model virtual character located in a virtual environment and at least one candidate bone point, displaying, in response to a selection operation on a target bone point of the at least one candidate bone point, an editing control configured to edit the target bone point, and rotating a bone corresponding to the target bone point in the virtual environment in response to an editing operation on the editing control. This application provides a precise adjustment scheme for a pose of a virtual character, and further describes techniques for saving, using, and sharing custom poses in a virtual environment.

### CROSS-REFERENCE TO RELATED APPLICATIONS

This application is a Continuation Application of PCT Application No. PCT/CN2024/087699, filed Apr. 15, 2024, which claims priority to Chinese Patent Application No. 202310747687.4, filed on Jun. 21, 2023, each entitled “POSE EDITING METHOD AND APPARATUS FOR VIRTUAL CHARACTER, DEVICE, AND STORAGE MEDIUM” and each of which is incorporated herein by reference in its entirety.

### FIELD

Aspects described herein relate to the field of three-dimensional virtual environments, and in particular, to a pose editing techniques for virtual characters.

### BACKGROUND

In a game supporting a three-dimensional virtual environment, a user may control a virtual character in the three-dimensional virtual environment to perform various activities, such as walking, running, attacking, and releasing a virtual skill.

In the related art, the virtual character is implemented through a three-dimensional skeleton model. Poses of the virtual character in various activity states are presented based on a preset skeleton animation. The user may control the virtual character to move to different positions in the three-dimensional virtual environment, and use the preset skeleton animation to strike poses for photo-taking and sharing.

However, the poses can only be a subset of the preset skeleton animation, making the poses that the user can capture and share extremely limited.

### SUMMARY

This application provides a pose editing method and apparatus for a virtual character, a device, and a storage medium. Technical solutions are as follows:

According to an aspect described herein, a pose editing method for a virtual character is provided. The method is performed by a computer device, and the method includes:
displaying a model virtual character located in a virtual environment and at least one candidate bone point;
displaying, in response to a selection operation on a target bone point of the at least one candidate bone point, an editing control configured to edit the target bone point; and
rotating a bone corresponding to the target bone point in the virtual environment in response to an editing operation on the editing control.

According to an aspect described herein, a pose editing apparatus for a virtual character is provided. The apparatus includes:
a display module, configured to display a model virtual character located in a virtual environment and at least one candidate bone point;
a selection module, configured to display, in response to a selection operation on a target bone point of the at least one candidate bone point, an editing control configured to edit the target bone point; and
an editing module, configured to rotate a bone corresponding to the target bone point in the virtual environment in response to an editing operation on the editing control.

According to another aspect described herein, a computer device is provided. The computer device includes a processor and a memory, the memory having a computer program stored therein, the computer program being loaded and executed by the processor to implement the pose editing method for a virtual character described above.

According to another aspect described herein, a computer-readable storage medium is provided. The computer-readable storage medium has a computer program stored therein, the computer program being loaded and executed by a processor to implement the pose editing method for a virtual character described above.

According to another aspect described herein, a computer program product is provided. The computer program product has a computer program stored therein, the computer program being loaded and executed by a processor to implement the pose editing method for a virtual character described above.

According to another aspect described herein, a chip is provided. The chip includes a programmable logic circuit and/or program instructions, a computer device installed with the chip being configured to implement the pose editing method for a virtual character described above.

Beneficial effects brought by the technical solutions provided in the aspects described herein are at least as follows:

By providing an editing control for a target bone point for a player, and rotating a bone corresponding to the target bone point in a virtual environment in response to an editing operation on the editing control, the bone corresponding to the target bone point is precisely controlled, thereby providing a precise pose editing scheme for the player. A user can conveniently generate various custom poses, so as to subsequently apply the generated custom pose to a virtual character controlled by the current user and/or another user.

### BRIEF DESCRIPTION OF THE DRAWINGS

FIG. 1 is a structural block diagram of a computer system according to an aspect described herein.

FIG. 2 is an interface diagram of a pose editing method for a virtual character according to an aspect described herein.

FIG. 3 is a flowchart of a pose editing method for a virtual character according to an aspect described herein.

FIG. 4 is a schematic diagram of a pose editing interface for a virtual character according to an aspect described herein.

FIG. 5 is a flowchart of a method for activating a pose editing function according to an aspect described herein.

FIG. 6 is a schematic diagram of a first entry of a pose editing function according to an aspect described herein.

FIG. 7 is a schematic diagram of a second entry of a pose editing function according to an aspect described herein.

FIG. 8 is a schematic diagram of a working principle of a camera model in a virtual environment according to an aspect described herein.

FIG. 9 is a flowchart of a method for setting an initial pose according to an aspect described herein.

FIG. 10 is a schematic diagram of a skeleton model of a virtual character according to an aspect described herein.

FIG. 11 is a flowchart of a pose editing method for a virtual character according to an aspect described herein.

FIG. 12 is a schematic diagram of a pose editing interface according to an aspect described herein.

FIG. 13 is a flowchart of a pose editing method for a virtual character according to an aspect described herein.

FIG. 14 is a schematic diagram of an interface for three rotation controls according to an aspect described herein.

FIG. 15 is a tabular diagram of a bone point configuration for a virtual character according to an aspect described herein.

FIG. 16 is a flowchart of a method for saving a custom pose according to an aspect described herein.

FIG. 17 is a flowchart of a method for applying a custom pose according to an aspect described herein.

FIG. 18 is a schematic diagram of an application interface for a custom pose according to an aspect described herein.

FIG. 19 is a schematic diagram of a sharing interface for a custom pose according to an aspect described herein.

FIG. 20 is a schematic diagram of a sharing interface for a custom pose according to an aspect described herein.

FIG. 21 is a flowchart of a pose editing method for a virtual character according to an aspect described herein.

FIG. 22 is a structural schematic diagram of a pose editing apparatus for a virtual character according to an aspect described herein.

FIG. 23 is a structural block diagram of a computer device according to an aspect described herein.

### DETAILED DESCRIPTION

First, related technologies in the aspects described herein are briefly described.

Virtual environment: It is a scene or environment displayed or provided when a client of an application is run on a terminal. The application includes, but is not limited to, a game application, an extended reality (XR) application, a social application, an interactive entertainment application, and the like. The virtual environment may be a simulated scene of a real world, a semi-simulated and semi-fictional scene, or a purely fictional scene. The virtual environment may be a two-dimensional virtual environment, a 2.5-dimensional virtual environment, or a three-dimensional virtual environment. The following aspects are described by using an example in which the virtual environment is a three-dimensional virtual environment.

Virtual character: It is a character that can move in the virtual environment. The virtual character may be in a in a character form, an animal form, a cartoon form, or another form. This is not limited in the aspects described herein. The virtual character may be displayed in a three-dimensional form or in a two-dimensional form. The aspects described herein are described by using the three-dimensional form as an example, but this is not limited thereto.

Bone chain: The virtual character in this application is implemented by using a skeleton model, and one skeleton model includes at least one bone chain. Each bone chain is constructed by one or more rigid bones, with joints connected between two adjacent bones. The joint may or might not have a movement capability. Some bones may rotate and move around the joints, and bone poses may be adjusted by adjusting joint parameters of the joints, thereby adjusting the skeleton pose, and finally implementing pose adjustment of the virtual character.

Inverse kinematics (IK): It is a technology configured for determining the skeleton pose of the virtual character. If the skeleton model of the virtual character is considered as a hierarchical bone chain structure, a bone part at the root of the bone chain may be referred to as a root bone, and a bone part at the farthest end of the bone chain may be referred to as an end bone. For example, in the IK technology, information such as a position and an angle of each joint on a bone chain to which the end belongs is solved based on a determined target position of the end bone, so that the end bone of the virtual character can move to the target position, achieving a technology of obtaining an entire pose of the bone chain by using the position information of the end bone. Certainly, a position of another bone on the bone chain in the virtual environment may also be solved based on a determined position of an intermediate bone on the bone chain. This is not limited in the aspects described herein.

Modeling: It is a process of a user adjusting a virtual character to generate a personalized custom pose through a pose editor based on a preset initial pose of a system. Pose data and a pose preview of the custom pose may be saved as a modeling work, to facilitate applying or sharing the custom pose on virtual characters controlled by different accounts. The modeling work may be considered as a user generated content (UGC) work. In some aspects, the pose data includes at least one of a position, an angle, or coordinate information of a bone and each joint.

Modeling catalog: It is a network space or program function where a user uniformly stores modeling works generated by the user and modeling works collected from other users.

Convenient editing mode: A skeleton point of a virtual character is dragged, and other skeletons belonging to a same skeleton chain as the skeleton point are driven to change together, so as to adjust a pose of the virtual character. Since one drag can change positions of a plurality of bones at the same time, this is referred to as a convenient editing mode.

Expert editing mode: By rotating a bone point of a virtual character, a bone position corresponding to the bone point is changed, to precisely adjust a pose of the virtual character. Since each bone point can be precisely adjusted individually, the pose of the virtual character can be adjusted more subtly, which is referred to as an expert editing mode.

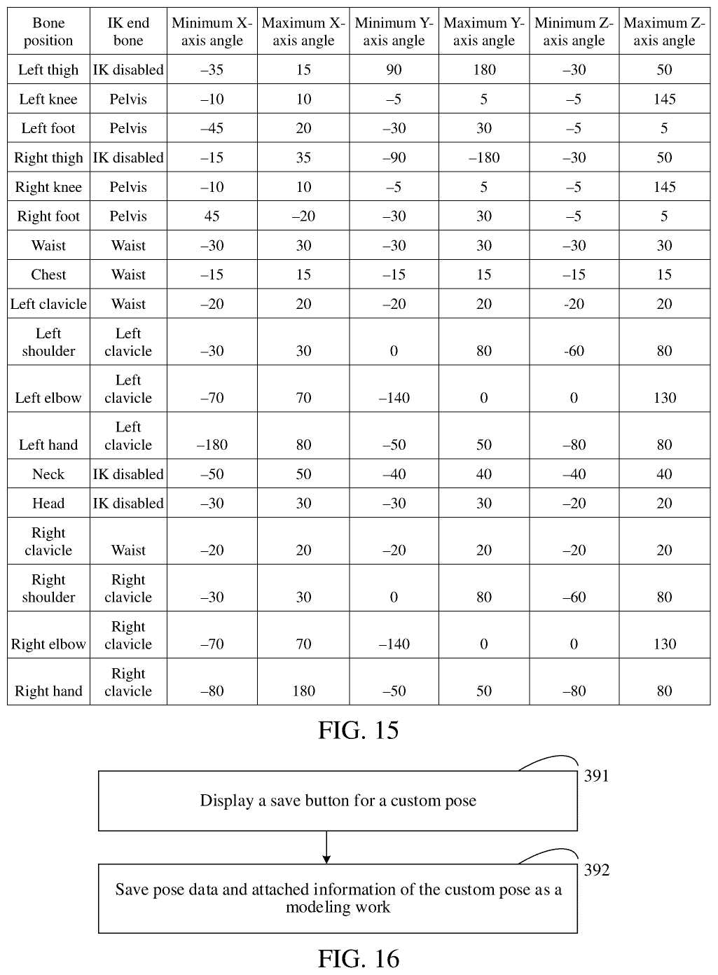

Physiological angle limit for a bone point: It is the configuration for whether each bone point allows for rotation on the x/y/z axes, and a maximum and minimum rotation angle for each bone point when the bone point is rotated on the x/y/z axes. For details, refer to FIG. 15.

Editing degree of freedom limitation for a bone point: It is the configuration for a maximum rotation angle variation based on a preset initial pose of a system when each bone point rotates about the x/y/z axes, and it is configured by a staff member or a user.

Share: It is to send a modeling work generated by a user to a network group, or share the modeling work to a friend account in a social relationship chain in a peer-to-peer manner. The social relationship chain may be a relationship chain in a game, or may be a relationship chain outside a game.

Collect: It is to save and collect modeling works generated and shared by others.

One-click apply: By using the one-click apply function, a custom pose created by a current user or another user may be quickly applied to a virtual character controlled by the current user.

Body shape: Body shapes of different virtual characters are classified as follows: an adult male body shape, an adult female body shape, a teenage boy body shape, a teenage girl body shape, an elderly body shape, a child body shape, and the like. Due to space limitations, the aspects described herein are described by using the adult male body shape, the adult female body shape, and the teenage girl body shape as an example.

Heads-up display (HUD) control: It is a picture displaying related information or controls within a game, and is usually displayed on the top of a virtual environment picture. The virtual environment picture is a picture obtained by observing a virtual environment through a camera model. The HUD control is the most effective manner for a game world to interact with players. Elements that can convey information to the players through a visual effect can be referred to as HUD. Common HUD controls include an operation control, an inventory bar, a map, a health bar, and the like. The heads-up display control is also referred to as a head-up display control. In this application, all or some of editing controls are in the form of HUD controls.

Using the game application as an example, in a virtual environment of a fight technology game (FTG), an action game (ACT), a multiplayer online battle arena (MOBA) game, a real-time strategy game (RTS), a massive/massively multiplayer online game (MMOG), a shooting game (STG), a first-person shooting game (FPS), a third-person shooting game (TPS), an arcade game, or the like, a pose/action of a virtual character controlled by a user is preset by the game, for example, a walking pose, a running pose, or a pose during skill release. The user cannot actively set the pose of the virtual character.

An aspect described herein provides a UGC function for a pose/action of a virtual character. This application supports a user in a game to customize and change bone positions of the virtual character based on preset basic poses of a system through a pose editor, to generate a personalized custom pose. In addition, the custom pose can be saved as a modeling work, and shared with other users, for others to use, collect, or the like. Through a complete UGC production-sharing-application-collection system, common public users can obtain a UGC creation work from top users within the game more conveniently, and creative desires, sharing desires, and social needs of the top users are satisfied. It helps fill idle time and creates a good closed loop of social experience.

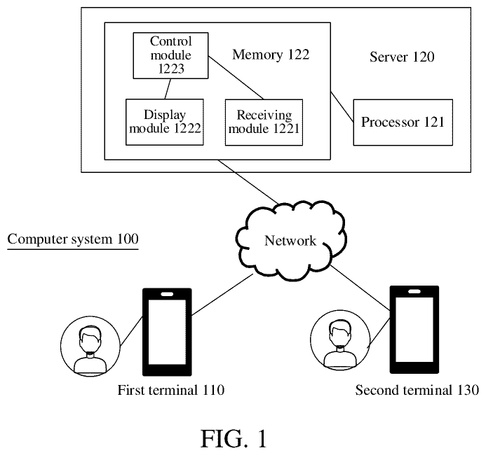

FIG. 1 is a structural block diagram of a computer system according to an illustrative aspect described herein. The computer system 100 includes at least one of a first terminal 110, a server 120, or a second terminal 130.

The first terminal 110 is installed with and runs a client of an application supporting a virtual environment. The application may be, for example, a game application, an XR application, a virtual social application, an interactive entertainment application, or a metaverse application. The first terminal 110 is a terminal used by a first user. A pose editor for a virtual character is set in the application, and is configured to generate, share, and collect the foregoing modeling work.

In some aspects, the first terminal 110 may be considered as the first user using the first terminal 110.

The first terminal 110 is connected to the server 120 through a wireless network or wired network.

The server 120 includes one of one server, a plurality of servers, a cloud computing platform, and a virtualization center. For example, the server 120 includes a processor 121 and a memory 122. The memory 122 further includes a receiving module 1221, a display module 1222, and a control module 1223. The server 120 is configured to provide a backend service for an application supporting the generation and/or display of a hit animation. In some aspects, the server 120 takes on primary computing work, and the first terminal 110 and the second terminal 130 takes on secondary computing work; or the server 120 takes on secondary computing work, and the first terminal 110 and the second terminal 130 takes on primary computing work; or a distributed computing architecture is used for collaborative computing between the server 120, the first terminal 110, and the second terminal 130.

The second terminal 130 is installed with and runs a client of an application supporting a virtual environment. The application may be, for example, a game application, an XR application, a virtual social application, an interactive entertainment application, or a metaverse application. The second terminal 130 is a terminal used by a second user. A pose editor for a virtual character is set in the application, and is configured to generate, share, and record the foregoing modeling work.

In some aspects, the second terminal 130 may be considered as the second user using the second terminal 130.

In some aspects, the first user and the second user are or are not in a same field of view. Alternatively, the first user and the second user are or are not in a same battle. Alternatively, the first user and the second user are or are not in a same battlefield. In some aspects, the first user and the second user may belong to a same team or a same organization, have a friend relationship, or have a temporary communication permission.

In some aspects, the application programs installed on the first terminal 110 and the second terminal 130 are the same, or the application programs installed on the first terminal 110 and the second terminal 130 are a same type of application programs on different control system platforms. The first terminal 110 may generally refer to one of a plurality of terminals, and the second terminal 130 may generally refer to one of a plurality of terminals. This aspect is described by only using the first terminal 110 and the second terminal 130 as an example. Device types of the first terminal 110 and the second terminal 130 are the same or different. The device types include, but are not limited to, at least one of a smartphone, a tablet computer, an e-book reader, a laptop computer, a desktop computer, a television, an augmented reality (AR) terminal, a virtual reality (VR) terminal, a mixed reality (MR) terminal, an XR terminal, a baffle reality (BR) terminal, a cinematic reality (CR) terminal, or a deceive reality (DR) terminal. The following aspects are described by using an example in which the terminal includes a smartphone.

A person skilled in the art may know that there may be more or fewer terminals or users. For example, there may be only one terminal or user, or there be dozens or hundreds of terminals or users, or more. The quantity of terminals or users and the device types are not limited in the aspects described herein.

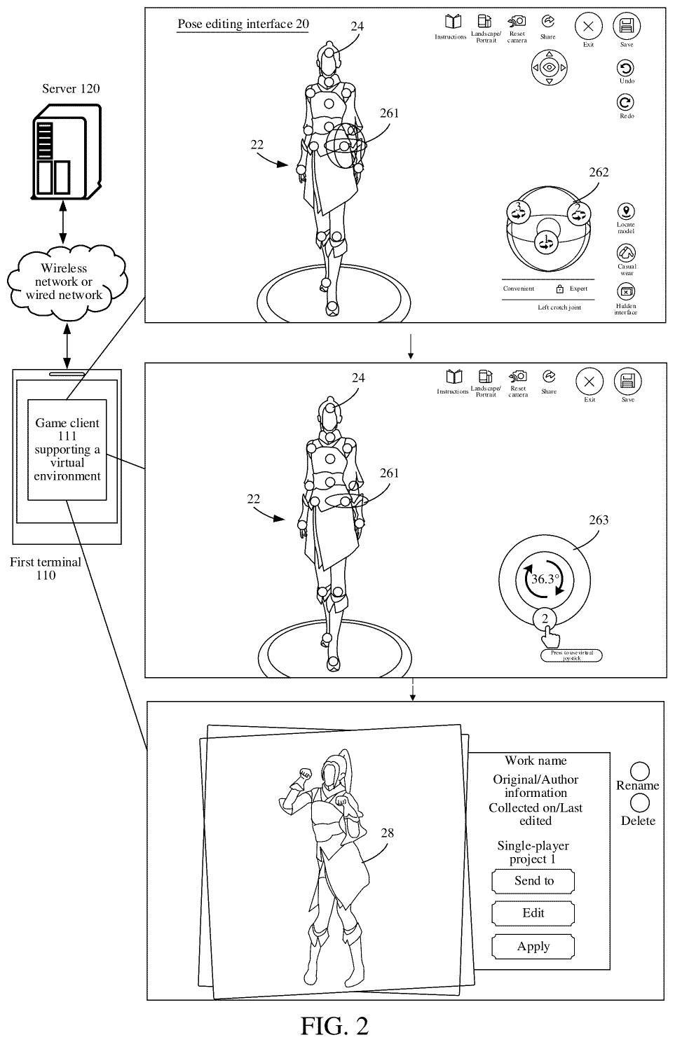

FIG. 2 is a schematic diagram of an interface for a pose editing method for a virtual character according to an aspect described herein. A game client supporting a virtual environment 111 is run in the first terminal 110. The game client 111 provides a pose editor for a virtual character. After a user activates the pose editor, a pose editing interface 20 is displayed. The pose editing interface 20 displays a model virtual character 22. The model virtual character 22 is displayed based on a skeleton model. There are a plurality of editable candidate bone points 24 on the model virtual character 22.

This aspect described herein provides an expert editing mode. The expert editing mode includes:

The user selects a target bone point on the model virtual character 22 that is expected to be edited. Rotation indicator line 261 of three coordinate axes are displayed on the selected target bone point. The three coordinate axes may be an x-axis in a horizontal direction, a y-axis in a vertical direction, and a z-axis in a longitudinal direction. In addition, a rotation control 1, a rotation control 2, and a rotation control 3 that respectively correspond to the three coordinate axes are displayed outside the model virtual character 22. The rotation control 1, the rotation control 2, and the rotation control 3 have at least one of two display forms: a button form 262 and a ring dial form 263.

Before a touch operation is detected, the rotation controls 1 to 3 are displayed in the button form 262 by default.

When a touch operation on a rotation control 2 (which may be a rotation control 1 or a rotation control 3) is detected, the other two rotation controls 1 and 3 are hidden, and display of the touched rotation control 2 is switched from the button form 262 to the ring dial form 263. In the ring dial form 263, a joystick may slide in a clockwise direction or an anticlockwise direction around a ring. In some aspects, the clockwise direction corresponds to a positive half-axis direction of a coordinate axis, and the anticlockwise direction corresponds to a negative half-axis direction of the coordinate axis. In some aspects, the anticlockwise direction corresponds to a positive half-axis direction of a coordinate axis, and the clockwise direction corresponds to a negative half-axis direction of the coordinate axis. The user rotates a position of a bone corresponding to the target bone point in the virtual environment by rotating the rotation control 2.

When a rotation operation of the user on a rotation control 2 ends, the other two rotation controls 1 and 3 are restored to display, and the rotated rotation control 2 is restored from the ring dial form 263 to the button form 262.

The user may perform multiple pose edits on different bone points, to adjust a pose of the model virtual character 22 to a desired custom pose 28. Then, the user may save the custom pose 28 as a modeling work (including at least one of pose data or a pose preview of the custom pose 28).

The custom pose 28 is a UGC work, which may be shared and applied among accounts of the game client. The custom pose 28 may be applied to a first virtual character controlled by the current user, or may be shared with another user to be applied to a second virtual character, a third virtual character, or the like controlled by the another user. Alternatively, after the custom pose 28 is saved by the current user, secondary editing may be performed to form another custom pose 28.

Information (including but not limited to user equipment information, user personal information, and the like), data (including but not limited to data for analysis, stored data, displayed data, and the like), and signals in this application are all authorized by users or fully authorized by all parties, and collection, use, and processing of related data need to comply with relevant laws, regulations, and standards of relevant countries and regions. For example, information involved in this application is obtained with full authorization. The terminal and the server cache the information only during operation of an application, and do not solidify related data for storing and reusing the information.

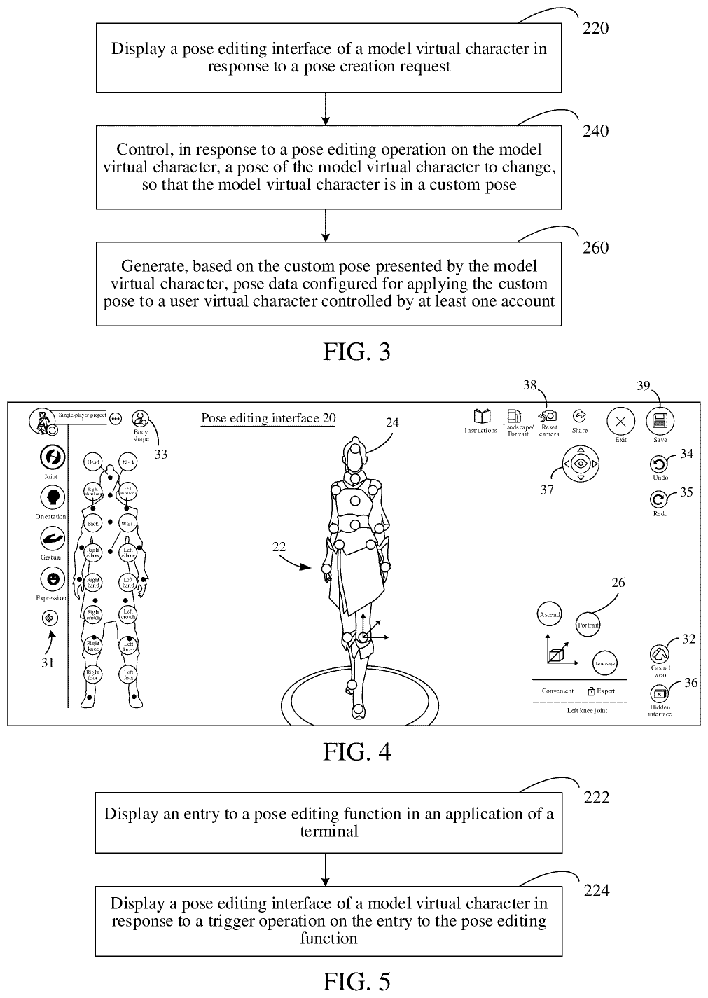

FIG. 3 is a schematic flowchart of a pose editing method for a virtual character according to an illustrative aspect described herein. The method is performed by a computer device. The computer device may be specifically a terminal. This aspect is described by using an example in which the method is performed by the first terminal 110 and/or the second terminal 130 shown in FIG. 1. The method includes at least some of the following operations 220, 240, 260.

Operation 220: Display a pose editing interface for a model virtual character in response to a pose creation request.

The terminal runs an application supporting a virtual environment, where the application may be a game client or a social client (for example, a metaverse social application). One or more virtual characters are provided in the application, each user account controls different virtual characters to complete a game match, and a friend relationship and/or a group relationship are formed between different user accounts.

For example, the game client includes a virtual character controlled by a user and a virtual character controlled by a non-user. The virtual character controlled by the user may be displayed in a display interface for the virtual character for the user to view. When the virtual character is displayed, a pose of the virtual character may be a preset pose of the game client. However, in this aspect described herein, the user may customize the pose of the virtual character.

The pose creation request is a request triggered in the game client of the terminal when the user intends to customize the pose of the virtual character. The pose editing interface is an interface configured for editing the pose of the virtual character. Specifically, if the user intends to customize the pose of the virtual character, the user performs a pose creation operation in the game client, to trigger the pose creation request. The terminal displays the pose editing interface in response to the pose creation request. The pose editing interface is configured for editing a pose of the model virtual character. The pose editing interface includes the model virtual character located in the virtual environment, and the user performs pose editing on the model virtual character.

The model virtual character is a virtual character used as a model in a pose editing process. The model virtual character may be one of a plurality of candidate model virtual characters. The plurality of candidate model virtual characters may be classified according to factors such as a body shape, gender, and age. Using an example in which virtual characters of three body shapes are provided, the plurality of candidate model virtual characters include: a first model virtual character corresponding to an adult male body shape, a second model virtual character corresponding to an adult female body shape, a third model virtual character corresponding to a teenage girl body shape, and a virtual character controlled by the current user (one of the foregoing three body shapes+a personalized face+personalized clothing). In some aspects, the model virtual character may be determined based on a first virtual character controlled by a currently logged-in first account. For example, factors such as a body shape, gender, and age of the model virtual character and the first virtual character may be the same or similar.

Operation 240: Control, in response to a pose editing operation on the model virtual character, the pose of the model virtual character to change, so that the model virtual character is in a custom pose.

The user performs the pose editing operation on the model virtual character in the pose editing interface, and the terminal controls, based on the pose editing operation performed by the user, the pose of the model virtual character to change as indicated by the pose editing operation. The changed model virtual character is in a custom pose edited by the user, and the custom pose refers to a changed pose obtained after the pose of the model virtual character is changed based on at least one pose editing operation. For example, a custom pose of the model virtual character after pose editing is: both legs bent to the left side, the left arm raised, and the right arm hanging down.

In different aspects, at least one of different body parts of the model virtual character is edited, so as to change the pose of the model virtual character. The different body parts include, but are not limited to, at least one of bone points (joints and/or bones), gestures, expressions, a face orientation, or an eye orientation. The foregoing body parts are merely an example, and the body parts may further include at least one of a head orientation, a head angle, a torso orientation, or a torso angle.

For example, referring to FIG. 4, a plurality of menu options 31: a joint menu, an orientation menu, a gesture menu, and an expression menu, are displayed on the left side of the pose editing interface 20. The joint menu is configured for opening an editing control related to bone points. The orientation menu is configured for opening an editing control related to a face orientation and an eye orientation. The gesture menu is configured for opening an editing control related to gestures. The expression menu is configured for opening an editing control related to expressions. More menus may further be set in the menu options based on an actual technical requirement. For example, an angle menu may be set, and the angle menu is configured for opening an editing control related to angle adjustment.

Various editing controls may be opened based on the menu options 31 shown in FIG. 4, and pose editing on different body parts of the model virtual character may be implemented through the editing controls. For example, the user may perform multiple pose edits on different bone points, to adjust the pose of the model virtual character to a desired custom pose.

Operation 260: Generate, based on the custom pose presented by the model virtual character, pose data configured for applying the custom pose to a virtual character controlled by at least one account.

A pose generation operation is an operation of generating the pose data of the custom pose of the model virtual character at this time after stopping the pose editing operation. Specifically, after the pose of the model virtual character reaches a desired pose of the user, the user stops performing the pose editing operation, and performs the pose generation operation on the model virtual character, to trigger a pose generation request. The terminal generates the pose data of the custom pose based on the model virtual character in the pose in response to the pose generation request, where the pose data is configured for indicating the custom pose.

In conclusion, in the method provided in this aspect described herein, by providing an editing control for a target bone point for a player, and in response to an editing operation on the editing control, changing a position of the target bone point in the virtual environment, and also changing a position of at least one bone bound to the target bone point in the virtual environment, pose editing of a plurality of skeletons can be changed through a single editing operation, thereby providing a convenient pose editing scheme for the player. The user can conveniently generate various custom poses, so as to subsequently apply the generated custom poses to a virtual character controlled by the current user or another user, thereby achieving a UGC generation, application, and sharing scheme for a pose of the virtual character.

### 1. Entry to Pose Editing Function

FIG. 5 is a flowchart of a method for activating a pose editing function according to an illustrative aspect described herein. This aspect is described by using an example in which the method is performed by a computer device, and the computer device is a terminal. The method includes at least some of operation 222 and operation 224.

Operation 222: Display an entry to a pose editing function in an application of a terminal.

The pose editing function refers to a function for editing a pose of a model virtual character. Assuming that the application is logged in with a first account, a user controls, in the application, a first virtual character corresponding to the first account to perform various activities, such as walking, running, attacking, and releasing a virtual skill. The application provides a plurality of functions, including, but are not limited to, a combat function, task execution, transaction, and the like. In this aspect, the application provides the entry to the pose editing function. There are one or more entries to the pose editing function. For example, the entry to the pose editing function includes, but is not limited to, at least one of the following:
a first entry to the pose editing function for new creation and editing based on a preset pose of a system; and
a second entry to the pose editing function for secondary editing based on the created pose.

Operation 224: Display a pose editing interface for the model virtual character in response to a trigger operation on the entry to the pose editing function.

The trigger operation is at least one of a click operation, a double-click operation, a press operation, a slide operation, a voice control operation, or an eye control operation.

The terminal displays the pose editing interface for the model virtual character in response to the trigger operation on the entry to the pose editing function. The pose editing interface includes: a model virtual character located in a virtual environment, and at least one editing control configured for pose editing.

In some aspects, the virtual environment is an independent virtual environment dedicated to pose editing. The virtual environment is different from a virtual environment in which a virtual character engages in daily activities. In some aspects, the virtual environment may alternatively be a part of the virtual environment in which the virtual character engages in daily activities, such as a yard or a house.

In some aspects, in a case that the entry to the pose editing function is the first entry, an initial pose of the model virtual character is a preset pose, for example, a standing pose with both hands hanging down. In a case that the entry to the pose editing function is the second entry, the initial pose of the model virtual character is a created pose.

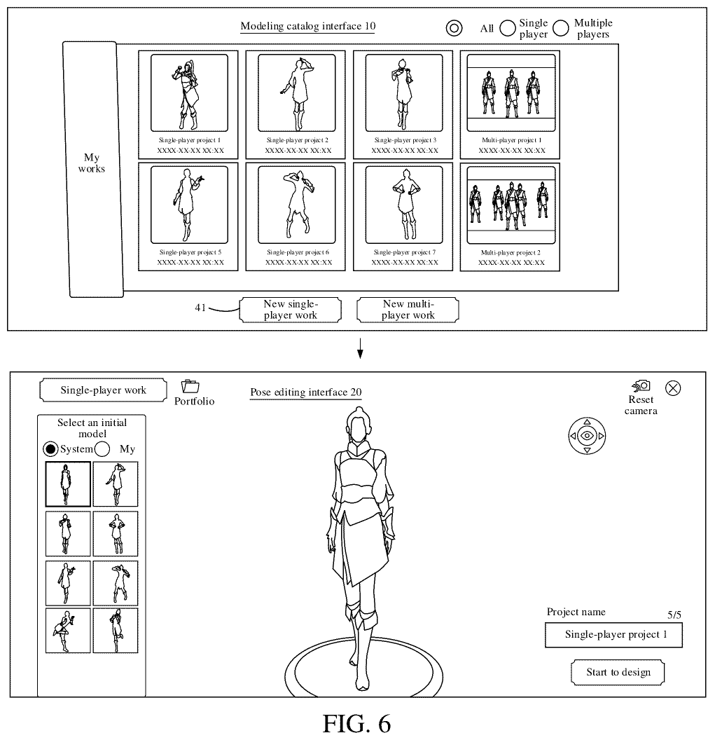

For example, as shown in FIG. 6, a modeling catalog interface 10 of the application displays an option 41 for creating a new single-player work, which may serve as the first entry to the pose editing function for new creation and editing based on the preset pose of the system. The terminal displays a pose editing interface 20 of the model virtual character in response to a trigger operation on the option 41 for creating a new single-player work. In the pose editing interface 20, the initial pose of the model virtual character is the preset pose.

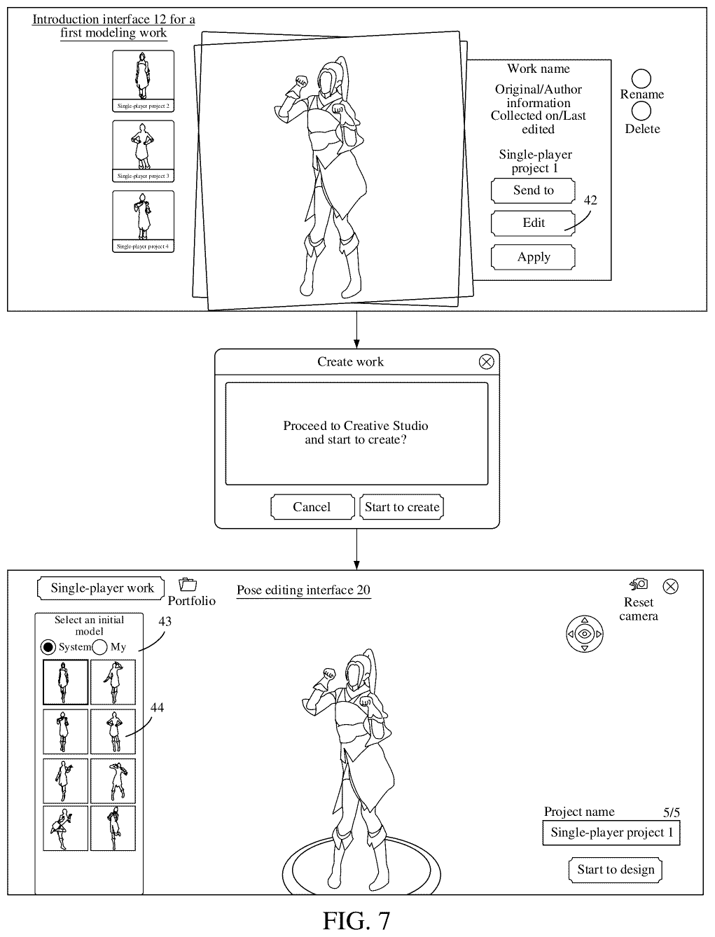

For example, as shown in FIG. 7, the modeling catalog interface 10 of the application displays the created work. The terminal displays, in response to a selection operation on a first modeling work, an introduction interface 12 of the first modeling work. The first modeling work is the modeling work created by the first account or another account. The introduction interface 12 of the first modeling work displays an editing button 42. The editing button 42 is the second entry to the pose editing function for secondary editing based on the created pose. The terminal displays the pose editing interface 20 of the model virtual character in response to a trigger operation on the editing button 42. In the pose editing interface 20, the pose of the model virtual character is a pose corresponding to the first modeling work. In some aspects, secondary editing requires user confirmation before proceeding, to avoid misoperation by the user.

For example, with reference to FIG. 4, the pose editing interface 20 further displays several general function buttons. For example, the several general function buttons include at least one of the following: a casual wear button 32, a body shape switch button 33, an undo button 34, a redo button 35, a hide button 36, a camera control widget 37, and a reset camera button 38. The general function buttons are described as follows.

### Casual Wear Button 32

The model virtual character 22 in the pose editing interface 20 is displayed based on a skeleton model and clothing attached to the outside of the skeleton model. By default, the clothing attached to the outside of the skeleton model is long clothing.

The terminal replaces the long clothing on the model virtual character 22 with form-fitting short clothing in response to a selection operation on the casual wear button 32 to expose body parts of the model virtual character 22, to help the user to view bone changes on the skeleton model of the model virtual character 22 in the pose editing process. The terminal replaces the form-fitting short clothing on the model virtual character 22 with the long clothing in response to a deselection operation on the casual wear button 32, to help the user to view an overall modeling change of the model virtual character 22 in the pose editing process.

### Body Shape Switch Button 33

The pose editing interface 20 further provides a plurality of candidate model virtual characters, and body shapes corresponding to the candidate model virtual characters may be different. This aspect is described by using an example in which three body shapes are provided. The plurality of candidate model virtual characters include: a first model virtual character corresponding to an adult male body shape, a second model virtual character corresponding to an adult female body shape, a third model virtual character corresponding to a teenage girl body shape, and a virtual character controlled by the user (one of the foregoing three body shapes+a personalized face+personalized clothing).

In some aspects, the terminal switches the model virtual character 22 in the pose editing interface 20 to a model virtual character of another body shape in response to a trigger operation on the body shape switch button 33.

In some aspects, the terminal displays the plurality of candidate model virtual characters in response to the trigger operation on the body shape switch button 33. The terminal switches, in response to a selection operation on one of the plurality of candidate model virtual characters, the model virtual character 22 in the pose editing interface 20 to the selected model virtual character.

### Undo Button 34 and Redo Button 35

The terminal undoes the most recent pose editing operation in response to a trigger operation on the undo button 34, to help the user to re-edit the pose of the model virtual character. The terminal redoes the most recently undone pose editing operation in response to a trigger operation on the redo button 35, to restore the pose of the model virtual character to the last edit of the user.

### Hide Button 36

The terminal hides all or some of the plurality of editing controls in response to a trigger operation on the hide button 36, to facilitate providing more display space for the model virtual character 22 in the pose editing interface 20.

### Camera Control Widget 37

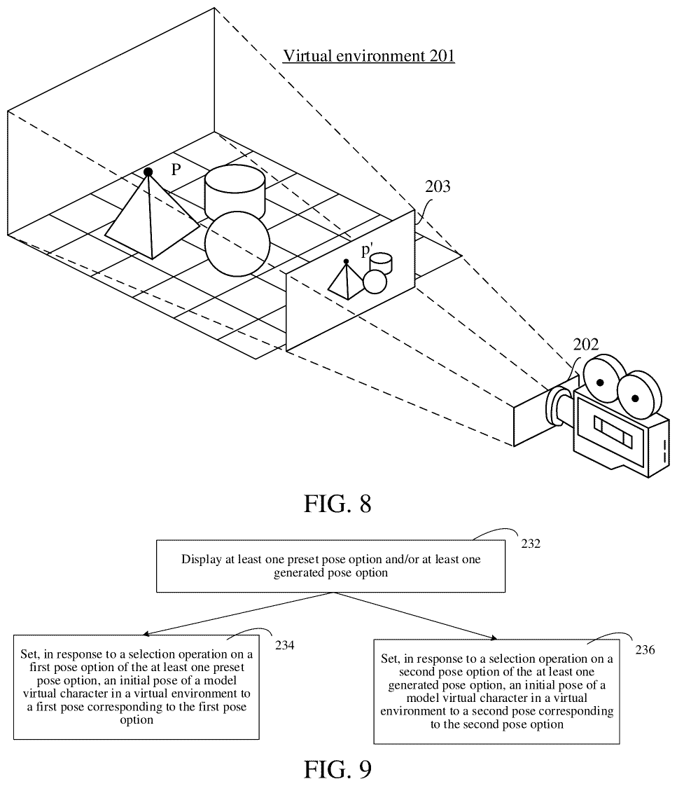

A picture of the model virtual character 22 located in the virtual environment is captured by a virtual camera model (camera for short), and the camera model is located in the virtual environment but is not displayed. FIG. 8 is a schematic diagram of a working principle of a camera model in a virtual environment according to an aspect described herein. The schematic diagram shows a process of mapping a feature point P in the virtual environment 201 to a feature point p′ in an imaging plane 203. Coordinates of the feature point P in the virtual environment 201 are in a three-dimensional form, and coordinates of the feature point p′ in the imaging plane 203 are in a two-dimensional form. A camera plane 202 is determined by a pose of the camera model, the camera plane 202 is a plane perpendicular to a photographing direction of the camera model, and the imaging plane 203 and the camera plane 202 are parallel to each other. The imaging plane 203 is a plane in which the virtual environment within the field of view is imaged by the camera model when the virtual environment 201 is observed.

The camera control widget 37 is configured to control a position of the camera in the virtual environment. Using an example in which the camera control widget 37 is a joystick, the terminal controls, in response to a drag operation performed on the joystick 37 in at least one of directions of up, down, left, and right, the camera to move in the virtual environment in a corresponding direction.

In some aspects, the terminal controls, in response to an upward slide operation in the blank of the pose editing interface 20, the camera to rotate upward in the virtual environment. The terminal controls, in response to a downward slide operation in the blank of the pose editing interface 20, the camera to rotate downward in the virtual environment. The terminal controls, in response to a leftward slide operation in the blank of the pose editing interface 20, the camera to rotate leftward in the virtual environment. The terminal controls, in response to a rightward slide operation in the blank of the pose editing interface 20, the camera to rotate rightward in the virtual environment.

In some aspects, the terminal controls, in response to a pinch-to-zoom operation or a mouse scroll zoom operation in the blank of the pose editing interface 20, the camera to move forward or backward in the virtual environment, to zoom in or out to adjust a size of a model virtual character in the virtual environment.

In some aspects, the camera control widget 37 is displayed in a form of a floating joystick. Some of the editing controls in the pose editing interface 20 are displayed by using a floating window. When the floating window is dragged to a position of the camera control widget 37, the camera control widget adaptively offsets to another idle position in the pose editing interface 20.

### Reset Camera Button 38

Since the user may change the position of the camera for multiple times, the terminal returns the position of the camera to a default initial position in response to a trigger operation on the reset camera button 38. For example, the default initial position of the camera is a center position directly in front of the model virtual character.

In some aspects, a single-player mode and a multi-player mode each require one default camera configuration, and at least some configuration parameters in the two default camera configurations for the single-player mode and a dual-player mode are different.

### 2. Manner of Determining Initial Pose

FIG. 9 is a flowchart of a method for setting an initial pose according to an illustrative aspect described herein. This aspect is described by using an example in which the method is performed by a computer device, and the computer device may be a terminal. The method includes at least some of operation 232, operation 234, and operation 236.

Operation 232: Display at least one preset pose option and/or at least one generated pose option.

The preset pose option is a pose option provided by the application, and the generated pose option is a pose option corresponding to the custom pose edited by the first account and/or another account.

In some aspects, the at least one generated pose option is a pose option corresponding to the custom pose collected by the first account.

For example, as shown in FIG. 7, the pose editing interface 20 displays an initial pose selection control 43. The initial pose selection control 43 has two menu bars: A first menu bar “System” is configured for triggering to display at least one preset pose option 44 in the initial pose selection control 43, and a second menu bar “My” is configured for triggering to display at least one generated pose option in the initial pose selection control 43.

In some aspects, the initial pose selection control 43 is in a display state by default when entering the pose editing interface. The display is canceled after the user selects an initial pose option. In a subsequent editing process, the terminal switches, in response to a display operation on the initial pose selection control 43, the initial pose selection control 43 from a hidden state to the display state. The terminal switches, in response to a hide operation on the initial pose selection control 43, the initial pose selection control from the display state to the hidden state.

For example, as shown in FIG. 7, the at least one preset pose option 44 includes at least one of the following: a gentle blowing pose, a wishing pose, a fist-raising pose, a hands-on-hips pose, and an arms-crossed pose.

Operation 234: Set, in response to a selection operation on a first pose option of the at least one preset pose option, an initial pose of the model virtual character in the virtual environment to a first pose corresponding to the first pose option.

The first pose option is one of the at least one preset pose option. In some aspects, the first pose option correspondingly stores pose data corresponding to the first pose. The terminal imports the pose data corresponding to the first pose into a skeleton model of the model virtual character in response to the selection operation on the first pose option of the at least one preset pose option, to set the initial pose of the model virtual character in the virtual environment to the first pose corresponding to the first pose option.

Operation 236: Set, in response to a selection operation on a second pose option of the at least one generated pose option, an initial pose of the model virtual character in the virtual environment to a second pose corresponding to the second pose option.

The second pose option is one of the at least one generated pose option. In some aspects, the second pose option correspondingly stores pose data corresponding to the second pose. The terminal imports the pose data corresponding to the second pose into a skeleton model of the model virtual character in response to the selection operation on the second pose option of the at least one generated pose option, to set the initial pose of the model virtual character in the virtual environment to the second pose corresponding to the second pose option.

In some aspects, in the pose editing process, the user may still change the initial pose of the model virtual character. In a process of switching to a next initial pose, if the initial pose before switching has been edited, a secondary confirmation is required before switching to the next initial pose.

In conclusion, according to the method provided in this aspect, by providing at least one preset pose option preset by a system, a user can use several relatively basic preset poses as a starting point for creating a custom pose, thereby reducing a large quantity of operations in a pose editing process. For an electronic device with limited operation manners, such as a mobile phone or a tablet computer, costs of human computer operations of the user can be reduced, making it easier to create a more personalized custom pose with fewer human-computer interactions.

According to the method provided in this aspect, further, by providing at least one generated pose option created by the current user and/or another user, the current user can use the custom pose generated by another user as a starting point for secondary creation, and can add creativity on creative ideas of another user, thereby facilitating generation of a custom pose that merges creative ideas of different users.

### 3. Pose Editing Function

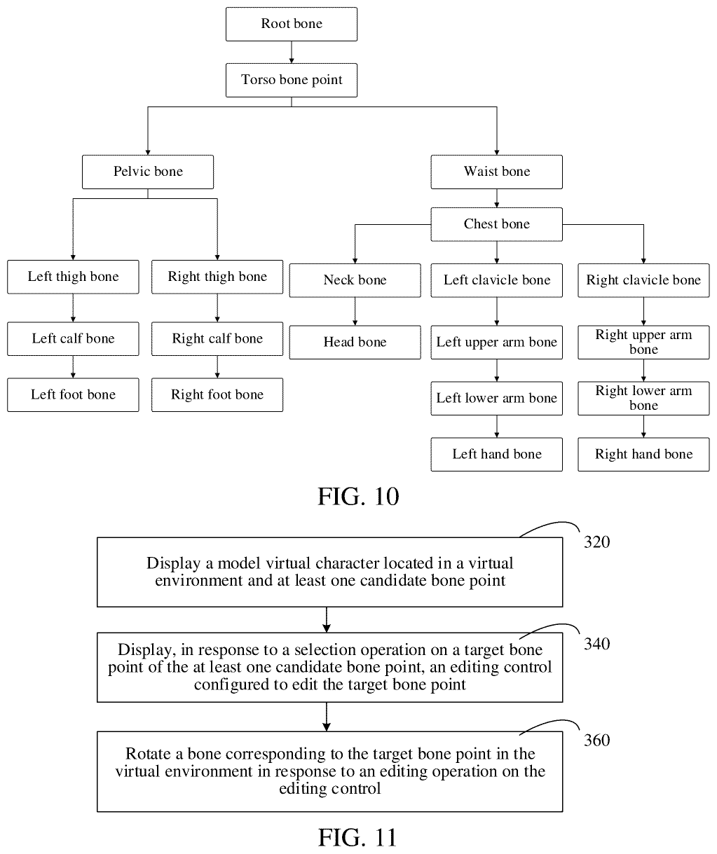

FIG. 10 is a schematic diagram of a skeleton model of a virtual character according to an illustrative aspect described herein. The skeleton model includes a root bone, a torso bone, a pelvic bone, a waist bone, a left thigh bone, a left calf bone, a left foot bone, a right thigh bone, a right calf bone, a right foot bone, a chest bone, a neck bone, a head bone, a left clavicle bone, a left upper arm bone, a left lower arm bone, a left hand bone, a right clavicle bone, a right upper arm bone, a right lower arm bone, and a right hand bone. The bones of the skeleton model form a plurality of bone chains. Each bone chain includes at least one bone, with joints formed between adjacent bones.

For example, the plurality of bone chains include at least one of the following:
A head bone chain, including: a head bone and a neck bone.
An upper-body bone chain, including: a chest bone, a waist bone, a left hand bone chain, and a right hand bone chain. The left hand bone chain includes: a left clavicle bone, a left upper arm bone, a left lower arm bone, and a left hand bone The right hand bone chain includes: a right clavicle bone, a right upper arm bone, a right lower arm bone, and a right hand bone.
A lower-body bone chain, including: a pelvic bone, a left leg bone chain, and a right leg bone chain. The left leg bone chain includes: a left thigh bone, a left calf bone, and a left foot bone. The right leg bone chain includes: a right thigh bone, a right calf bone, and a right foot bone.

Representative joints or bones in the skeleton model are set as editable bone points. For example, the editable bone points include: a head bone point, a neck bone point, a chest bone point, a waist bone point, a left shoulder bone point, a left elbow bone point, a left hand bone point, a right shoulder bone point, a right elbow bone point, a right hand bone point, a left crotch bone point, a left knee bone point, a left foot bone point, a right crotch bone point, a right knee bone point, and a right foot bone point.

For example, the pose editing interface displays at least one of the following mode selection buttons: a joint mode, an orientation mode, a gesture mode, and an expression mode. The joint mode includes a convenient editing mode and an expert editing mode.

The terminal displays, in response to a selection operation on the joint mode, an editing control related to pose editing of a bone point. Further, the terminal performs pose editing on the bone point and at least two bones on a bone chain corresponding to the bone point based on an inverse kinematics mode in response to a selection operation on the convenient editing mode. The terminal performs pose editing on a single bone corresponding to the bone point in response to a selection operation on the expert editing mode.

This application focuses on the related parts of the foregoing expert editing mode.

FIG. 11 is a flowchart of a pose editing method for a virtual character according to an illustrative aspect described herein. This aspect is described by using an example in which the method is performed by a computer device, and the computer device may be a terminal. The method includes at least some of operation 320, operation 340, and operation 360.

Operation 320: Display a model virtual character located in a virtual environment and at least one candidate bone point.

In the pose editing interface, the terminal displays the model virtual character located in the virtual environment and the at least one candidate bone point.

For example, the at least one candidate bone point includes: a head bone point, a neck bone point, a back bone point, a waist bone point, a left shoulder bone point, a left elbow bone point, a left hand bone point, a right shoulder bone point, a right elbow bone point, a right hand bone point, a left crotch bone point, a left knee bone point, a left foot bone point, a right crotch bone point, a right knee bone point, and a right foot bone point.

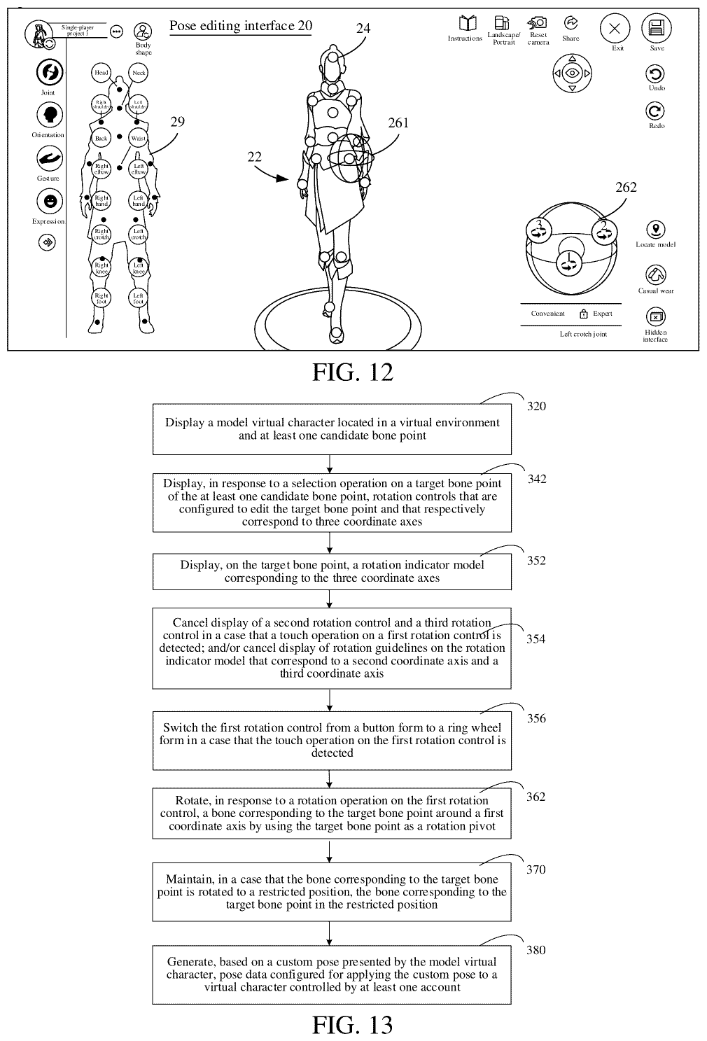

In some aspects, as shown in FIG. 12, the pose editing interface 20 includes bone points 29 displayed by using an HUD control and an option control for at least one candidate bone point connected to relevant parts on the bone points by using a lead wire. The bone points 29 are a two-dimensional schematic diagram independent of the model virtual character 22. Names of the current bone points are displayed on the option control for the candidate bone points.

In some aspects, as shown in FIG. 12, the pose editing interface 20 includes at least one candidate bone point 24 attached to the skeleton model of the model virtual character 22. The candidate bone points 24 are displayed as dot-shaped controls at corresponding positions on the skeleton model of the model virtual character 22.

Operation 340: Display, in response to a selection operation on a target bone point of the at least one candidate bone point, an editing control configured to edit the target bone point.

The selection operation is at least one of a click operation, a double-click operation, a press operation, a slide operation, a voice control operation, or an eye control operation.

In some aspects, the terminal displays, in response to a selection operation on a target bone point of at least one candidate bone point in a schematic diagram for bone points, an editing control configured to edit the target bone point. In some aspects, the terminal displays, in response to a selection operation on a target bone point of at least one candidate bone point on the model virtual character, an editing control configured to edit the target bone point.

For example, as shown in FIG. 12, the editing control corresponding to the target bone point includes: a rotation control 1, a rotation control 2, and a rotation control 3 that respectively correspond to three coordinate axes. The rotation control 1 is configured to perform rotational control around the x-axis, the rotation control 2 is configured to perform rotational control around the y-axis, and the rotation control 3 is configured to perform rotational control around the z-axis. In FIG. 12, a display form of the rotation control 1, the rotation control 2, and the rotation control 3 is a button form 262.

Operation 360: Rotate a bone corresponding to the target bone point in the virtual environment in response to an editing operation on the editing control.

This operation includes at least one of the following operations.
The terminal rotates the bone corresponding to the target bone point around the x-axis in the virtual environment in response to a first editing operation on the editing control, the first editing operation being an operation of editing the rotation control 1.
The terminal rotates the bone corresponding to the target bone point around the y-axis in the virtual environment in response to a second editing operation on the editing control, the second editing operation being an operation of editing the rotation control 2.

The terminal rotates the bone corresponding to the target bone point around the z-axis in the virtual environment in response to a third editing operation on the editing control, the third editing operation being an operation of editing the rotation control 3.

Each bone point has a corresponding bone. When a bone point is not a joint, a bone corresponding to the bone point is a bone directly indicated by the bone point. When the bone point is a joint, the bone corresponding to the bone point is a next-level bone connected to the joint. At least two bones on a bone chain, in a direction from the root bone to the end bone, may be sequentially referred to as a first-level bone, a second-level bone, a third-level bone, and the like.

In some aspects, the bone corresponding to the target bone point includes at least one of the following:
when the target bone point is a head bone point, bones corresponding to the head bone point are all the bones of the head; when the target bone point is a neck bone point, bones corresponding to the neck bone point are all the bones of the neck; when the target bone point is a back bone point, bones corresponding to the back bone point are bones between the back and the waist; and when the target bone point is a waist bone point, bones corresponding to the waist bone point are bones between the waist and the crotch.

When the target bone point is a left shoulder bone point, bones corresponding to the left shoulder bone point are left upper arm bones; when the target bone point is a left elbow bone point, bones corresponding to the left elbow bone point are left lower arm bones; when the target bone point is a left hand bone point, bones corresponding to the left hand bone point are all the bones of the left hand; when the target bone point is a right shoulder bone point, bones corresponding to the right shoulder bone point are right upper arm bones; when the target bone point is a right elbow bone point, bones corresponding to the right elbow bone point are right lower arm bones; and when the target bone point is a right hand bone point, bones corresponding to the right hand bone point are all the bones of the right hand.

When the target bone point is a left crotch bone point, bones corresponding to the left crotch bone point are left thigh bones; when the target bone point is a left knee bone point, bones corresponding to the left knee bone point are left calf bones; when the target bone point is a left foot bone point, bones corresponding to the left foot bone point are all the bones of the left foot; when the target bone point is a right crotch bone point, bones corresponding to the right crotch bone point are right thigh bones; when the target bone point is a right knee bone point, bones corresponding to the right knee bone point are right calf bones; and when the target bone point is a right foot bone point, bones corresponding to the right foot bone point are all the bones of the right foot.

When the target bone point is not a joint, the bone corresponding to the target bone point is rotated in the virtual environment by using a midpoint or a center of the bone corresponding to the target bone point as a rotation center. When the target bone point is a joint, the bone corresponding to the target bone point is rotated in the virtual environment by using the target bone point as a rotation center.

In conclusion, according to the method provided in this aspect, by providing an editing control for a target bone point for a player, and rotating a bone corresponding to the target bone point in a virtual environment in response to an editing operation on the editing control, the bone corresponding to the target bone point is precisely controlled, thereby providing a precise pose editing scheme for the player. The user can conveniently generate various custom poses, so as to subsequently apply the generated custom pose to a virtual character controlled by the current user or another user.

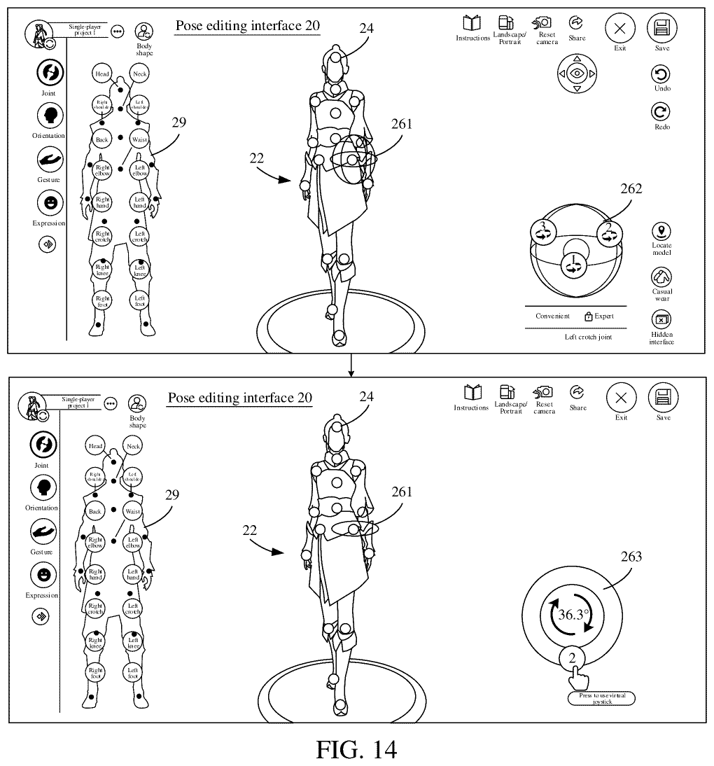

FIG. 13 is a flowchart of a pose editing method for a virtual character according to an illustrative aspect described herein. This aspect is described by using an example in which the method is performed by a computer device, and the computer device may be a terminal. The method includes at least some of operation 320, operation 342, operation 352, operation 354, operation 356, operation 362, operation 370, and operation 380:

Operation 320: Display a model virtual character located in a virtual environment and at least one candidate bone point.

Operation 342: Display, in response to a selection operation on a target bone point of the at least one candidate bone point, rotation controls that are configured to edit the target bone point and that respectively correspond to three coordinate axes, each rotation control being configured to implement rotational control corresponding to one of the three coordinate axes.

For example, as shown in FIG. 14, the editing control configured to edit the target bone point includes: a rotation control 1, a rotation control 2, and a rotation control 3 that respectively correspond to the three coordinate axes, and each rotation control is configured to implement rotational control corresponding to one of the three coordinate axes. The rotation control 1 is configured to perform rotational control around the x-axis, the rotation control 2 is configured to perform rotational control around the y-axis, and the rotation control 3 is configured to perform rotational control around the z-axis. In FIG. 14, a display form of the rotation control 1, the rotation control 2, and the rotation control 3 is a ring dial form 263.

The virtual environment is constructed based on a world coordinate system. The three coordinate axes are three coordinate axes in the world coordinate system, and are three coordinate axes on a private coordinate system constructed by using the target bone point as an origin. For example, the rotation controls respectively corresponding to the three coordinate axes include: a rotation control 1 corresponding to the x-axis, a rotation control 2 corresponding to the y-axis, and a rotation control 3 corresponding to the z-axis.

Most target bone points are supported to rotate on the three coordinate axes. Due to limitations such as limb bending limits, only a small quantity of target bone points are supported on one or two coordinate axes. In this case, a rotation control corresponding to a non-rotatable coordinate axis is displayed in an unavailable state or hidden.

In some aspects, the rotation controls respectively corresponding to the three coordinate axes are implemented by using the HUD control, and are displayed separately from the model virtual character 22.

Operation 352: Display, on the target bone point, a rotation indicator model corresponding to the three coordinate axes.

To facilitate observing the effect of each rotation control, the terminal displays, in response to a selection operation on a target bone point of the at least one candidate bone point, a rotation indicator model corresponding to the three coordinate axes on the target bone point.

For example, as shown in FIG. 14, the rotation indicator model 261 is a spherical model, a circle center of the spherical model is the target bone point, and the spherical model displays rotation guidelines corresponding to three coordinate axes. A rotation guideline corresponding to the x-axis is an annular line using the x-axis as a rotation axis, having a radius equal to a spherical radius and a display color the same as a color of the x-axis. A rotation guideline corresponding to the y-axis is an annular line using the y-axis as a rotation axis, having a radius equal to a spherical radius and a display color the same as a color of the y-axis. A rotation guideline corresponding to the z-axis is an annular line using the z-axis as a rotation axis, having a radius equal to a spherical radius and a display color the same as a color of the z-axis.

Operation 354: Cancel display of the second rotation control and the third rotation control in a case that a touch operation on the first rotation control is detected; and/or cancel display of the rotation guidelines on the rotation indicator model that correspond to the second coordinate axis and the third coordinate axis.

The touch operation is a touch down event detected on the first rotation control. For example, one click operation includes one touch down event and one touch up event. One slide/drag operation includes: one touch down event, at least one touch move event, and one touch up event. In some aspects, the touch down event is also referred to as a touch start event, and the touch-up event is also referred to as a touch end event.

The first rotation control is a selected rotation control of the three rotation controls. A first coordinate axis is one of the three coordinate axes. For example, referring to FIG. 14, an example in which the rotation control 2 is a first rotation control, the rotation control 1 is a second rotation control, and the rotation control 3 is a third rotation control is used for description.

The second rotation control is a rotation control corresponding to a second coordinate axis, the third rotation control is a rotation control corresponding to a third coordinate axis, and the second coordinate axis and the third coordinate axis are the other two coordinate axes in the three coordinate axes other than the first coordinate axis.

Due to a limited display area on the terminal, to provide more user operation areas, display of the second rotation control 1 and the third rotation control 3 is canceled in a case that a touch operation on the first rotation control 2 is detected.

Similarly, to avoid misleading the user, in a case that the touch operation on the first rotation control is detected, display of rotation guidelines corresponding to the second coordinate axis and the third coordinate axis on the rotation indicator model 261 is canceled, and only a rotation guideline corresponding to the first coordinate axis is reserved.

Operation 356: Switch the first rotation control from the button form to the ring dial form in a case that the touch operation on the first rotation control is detected.

For example, referring to FIG. 14, the rotation control 1, the rotation control 2, and the rotation control 3 all have two display forms: the button form 262 and the ring dial form 263. The ring dial form 263 includes a ring dial and a joystick on the ring dial. By default, the three rotation controls are displayed in the button form 262. A display area of the rotation control in a single button form 262 is smaller than a display area of the rotation control in a single ring dial form 263.

The first rotation control is switched from the button form 262 to the ring dial form 263 in a case that the touch operation on the first rotation control is detected. Since display of the second rotation control and the third rotation control has been canceled, although the ring dial form 263 is relatively large, a display area of the ring dial form is the same as that of the three rotation controls before the display is canceled or a difference between the areas is less than a threshold.

Operation 362: Rotate, in response to a rotation operation on the first rotation control, the bone corresponding to the target bone point around the first coordinate axis by using the target bone point as a rotation pivot.

The terminal rotates, in response to an operation of rotating the first rotation control in a first rotation direction, the bone corresponding to the target bone point around the first coordinate axis in a clockwise direction by using the target bone point as the rotation pivot; and/or, the terminal rotates, in response to an operation of rotating the first rotation control in a second rotation direction, the bone corresponding to the target bone point around the first coordinate axis in an anticlockwise direction by using the target bone point as the rotation pivot.

In some aspects, the first rotation direction is the clockwise direction, and the second rotation direction is the anticlockwise direction. In some aspects, the first rotation direction is the anticlockwise direction, and the second rotation direction is the clockwise direction.

For example, as shown in FIG. 14, a real-time rotation angle is further displayed at a central position of the ring dial form 263. The rotation angle is an included angle between the rotated bone and the positive half axis of the first coordinate axis.

Operation 370: Maintain, in a case that the bone corresponding to the target bone point is rotated to a restricted position, the bone corresponding to the target bone point in the restricted position.

When the skeleton corresponding to the target skeleton point is rotated to the restricted position, if a rotation operation in a same rotation direction is continuously received, the skeleton corresponding to the target skeleton point is kept in the restricted position. In other words, in a case that the bone corresponding to the target bone point is maintained in the restricted position, the rotation control no longer responds to an editing operation beyond the restricted position, but can still respond to an editing operation within the restricted position.

The restricted position includes at least one of a first restricted position or a second restricted position.

The first restricted position is set based on a skeletal physiological angle limit of a model virtual character. For example, there are limits to an angle at which a human arm can twist backward, and limits to an angle at which a human head can tilt backward.

The second restricted position is set based on an editing degree of freedom limitation. The editing degree of freedom may be set by a developer or a user. For example, after creating a custom pose, the user does not want a waist design of the custom pose to be significantly changed, and therefore, may set an editing degree of freedom limitation for the waist of the custom pose. Afterwards, other users can only make minor adjustments to the waist of the model virtual character within the editing freedom limitation.

In some aspects, in a case that a touch off operation on the first rotation control is detected, the terminal restores display of the second rotation control and the third rotation control; and/or the terminal restores display of the rotation guidelines on the rotation indicator model that correspond to the second coordinate axis and the third coordinate axis.

In some aspects, in a case that the touch off operation on the first rotation control is detected, the terminal switches the first rotation control from the ring dial form back to the button form.

Operation 380: Generate, based on the custom pose presented by the model virtual character, pose data configured for applying the custom pose to a user virtual character controlled by at least one account.

A pose generation operation is an operation of generating the pose data of the custom pose of the model virtual character at this time after stopping the pose editing operation. Specifically, after the pose of the model virtual character reaches a desired pose of the user, the user stops performing the pose editing operation, and performs the pose generation operation on the model virtual character, to trigger a pose generation request. The terminal generates the pose data of the custom pose based on the model virtual character in the custom pose in response to the pose generation request. The pose data may be absolute pose data or relative pose data. The absolute pose data is configured for indicating a position of the custom pose in the virtual environment, and the relative pose data is configured for indicating a bone offset value of the custom pose relative to the initial pose.

The pose data and attached information of the custom pose are saved as a modeling work of the custom pose. The attached information includes at least one of the following: account information of a creator, creation time, personalized information of the model virtual character, body shape information of the model virtual character, pose data of an initial pose of the model virtual character, a name of the custom pose, and a preview of the custom pose.

The modeling work of the custom pose may be applied to a virtual character controlled by the first account, or may be shared by the first account with another account and then applied to a virtual character controlled by the another account. Therefore, the custom pose is used as a type of UGC content, to be shared and applied between accounts.

In conclusion, according to the method provided in this aspect, by providing an editing control for a target bone point for a player, and rotating a bone corresponding to the target bone point in a virtual environment in response to an editing operation on the editing control, the bone corresponding to the target bone point is precisely controlled, thereby providing a precise pose editing scheme for the player. The user can conveniently generate various custom poses, so as to subsequently apply the generated custom poses to a virtual character controlled by the current user or another user, thereby achieving a UGC generation, application and sharing scheme for a pose of the virtual character.

According to the method provided in this aspect, further, by providing rotation controls respectively corresponding to three coordinate axes, the user can perform precise pose editing on a single bone in three directions, namely, the x-axis, the y-axis, and the z-axis. Through multiple pose edits by the user, the model virtual character can be edited into various desired poses. This provides a level of precision in pose editing.

According to the method provided in this aspect, further, by canceling display of rotation controls corresponding to a second coordinate axis and a third coordinate axis in a case that a rotation control corresponding to a first coordinate axis is selected, a quantity of controls displayed on the pose editing interface can be reduced, thereby reducing information interference to the user while providing a larger operation space for the user.

According to the method provided in this aspect, further, after the touch operation on the rotation control corresponding to the first coordinate axis ends, by switching a first rotation control from the ring dial form back to the button form, and restoring display of a second rotation control and a third rotation control, a plurality of rotation controls are displayed on the pose editing interface by using a smaller area. When the terminal is a device such as a mobile phone or a tablet computer, it makes full use of a limited screen area to provide first-level entries to the plurality of rotation controls.

In some aspects, the foregoing method further includes:

The terminal obtains a first custom pose and a second custom pose. The first custom pose is determined as an action start pose, and the second custom pose is determined as an action end pose. Pose data of the first custom pose, pose data of the second custom pose, and an expected quantity of intermediate poses are input into a neural network model. The neural network model predicts pose data of at least one intermediate pose transitioning from the first custom pose to the second custom pose. The expected quantity of intermediate poses is set by the user.

The terminal generates a custom action for the model virtual character based on the pose data of the first custom pose, the at least one intermediate pose, and the second custom pose. The custom action is a continuous and dynamic skeleton animation. The neural network model may be trained by using actions of virtual characters already designed in a game application as a training set.

### 4. Save of Custom Pose

FIG. 16 is a flowchart of a method for saving a custom pose according to an illustrative aspect described herein. This aspect is described by using an example in which the method is performed by a computer device, and the computer device may be a terminal. The method includes at least some of operation 391 and operation 392.

Operation 391: Display a save button for a custom pose.

There may be more than one display position and timing for the save button. For example, the save button may be displayed within a pop-up window, or may be displayed in the blank of the pose editing interface. For another example, the save button may be always displayed, or may be displayed when an operation is performed.

With reference to FIG. 12, the pose editing interface 20 displays a save button 39. In some aspects, when the pose editing interface is exited, a first pop-up window is displayed, and the save button is displayed within the first pop-up window. In some aspects, when an initial pose of a model virtual character is changed, a second pop-up window is displayed, and the save button is displayed within the second pop-up window.

Operation 392: Save pose data and attached information of the custom pose as a modeling work.

The pose data of the custom pose is absolute pose data, or relative pose data relative to the initial pose. The absolute pose data saves position information and rotation information of each bone of the model virtual character in a virtual environment. The relative pose data saves a pose offset value of each bone of the model virtual character relative to the initial pose. In some aspects, the pose offset value includes at least one of a position offset value or a rotation offset value of each bone relative to the initial pose.

The pose data and the attached information of the custom pose are saved as the modeling work of the custom pose. The attached information includes at least one of the following: a unique identifier of the custom pose, account information of a creator, creation time, personalized information of the model virtual character, body shape information of the model virtual character, pose data of an initial pose of the model virtual character, a name of the custom pose, and a preview of the custom pose.

In some aspects, the unique identifier of the custom pose is generated by a terminal or a server.

In conclusion, according to the method provided in this aspect, by saving the pose data and the attached information of the custom pose as the modeling work, the modeling work is saved as a type of UGC, thereby facilitating sharing and applying the custom pose between different accounts.

### 5. Application of Custom Pose

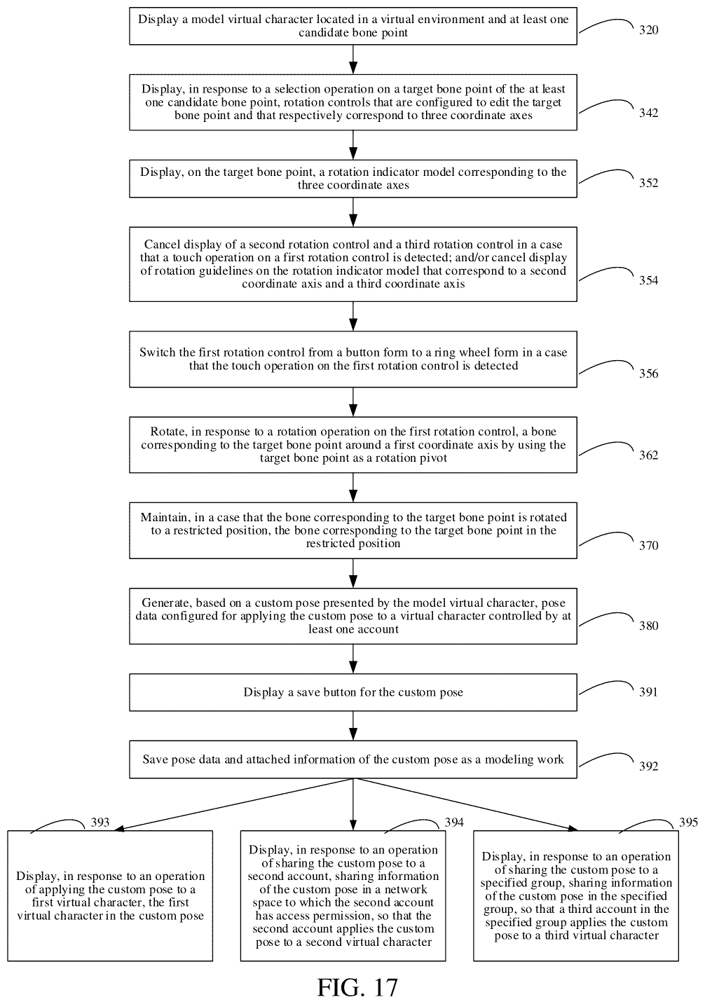

FIG. 17 is a flowchart of a method for applying a custom pose according to an illustrative aspect described herein. This aspect is described by using an example in which the method is performed by a computer device, and the computer device may be a terminal. The method includes at least some of operation 393, operation 394, and operation 395.

Operation 393: Display, in response to an operation of applying the custom pose to a first virtual character, the first virtual character in the custom pose.

The first virtual character is a virtual character controlled by a first account. The first account is an account currently logged in on the client.

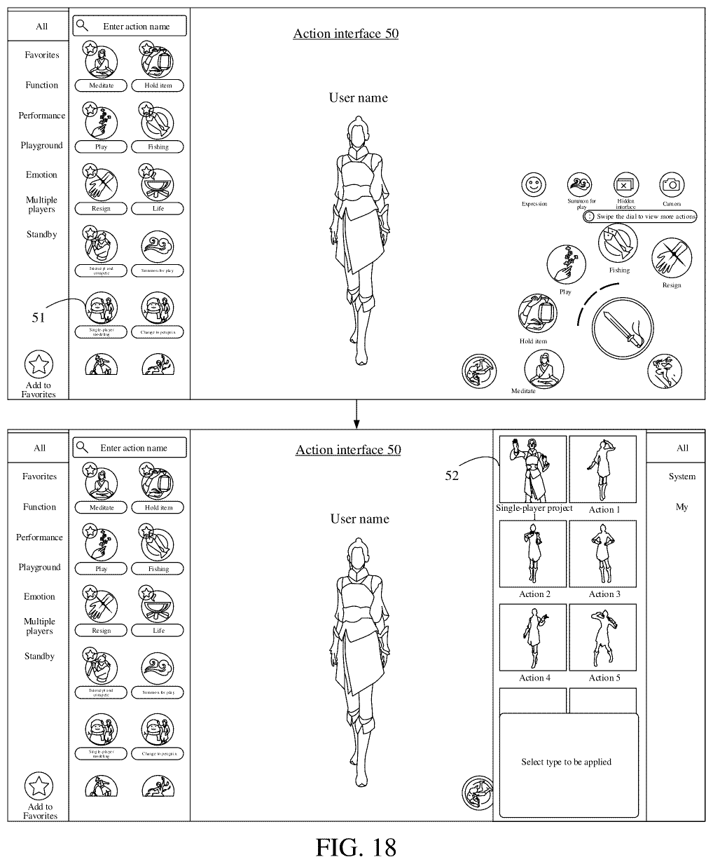

In some aspects, for example, as shown in FIG. 18, the client displays an action interface 50, and the action interface 50 displays a plurality of action options. The plurality of action options include a single-player modeling option 51. In response to a trigger operation on the single-player modeling option 51, a modeling catalog panel 52 is displayed. The modeling catalog panel 52 displays a plurality of modeling works, and each modeling work corresponds to a preset pose of a system or a custom pose. In some aspects, the modeling catalog panel 52 includes three menu bars: A first menu bar “System” is configured for triggering to display at least one preset pose option in the modeling catalog panel 52; a second menu bar “My” is configured for triggering to display at least one generated pose option in the modeling catalog panel 52; and a third menu bar “All” is configured for triggering to display all pose options owned or collected by a current account in the modeling catalog panel 52.

For example, in response to a selection operation of the user on a modeling work “single-player project 1”, the terminal applies a custom pose corresponding to the modeling work “single-player project 1” to the first virtual character.

In some aspects, the user may alternatively select a modeling work to apply it to the first virtual character through “Camera interface→Actions→Modeling→Right-side list”.

In some aspects, as shown in the top interface diagram in FIG. 7, in the introduction interface 12 of the first modeling work, in response to a trigger operation on an application control for the first modeling work, the terminal may alternatively apply the first modeling work to the first virtual character.

In some aspects, absolute pose data of the custom pose is obtained, the absolute pose data is applied to the first virtual character, and the first virtual character in the custom pose is displayed.

In some aspects, relative pose data of the custom pose is obtained. The relative pose data of the custom pose is an offset value of the custom pose relative to the initial pose. The absolute pose data of the initial pose corresponding to the custom pose is obtained, and the relative pose data of the custom pose and the pose data of the initial pose are superimposed, to obtain the absolute pose data of the custom pose. The absolute pose data is applied to the first virtual character, to display the first virtual character in the custom pose.

Operation 394: Display, in response to an operation of sharing the custom pose to a second account, sharing information of the custom pose in a network space to which the second account has access permission, so that the second account applies the custom pose to a second virtual character.

The second virtual character is a virtual character controlled by the second account.

In some aspects, the first account and the second account have a friend relationship. In response to an operation of sharing the custom pose to a chat window or a game mailbox corresponding to the second account, the terminal displays, in the chat window or the game mailbox to which the second account has access permission, the sharing information of the modeling work corresponding to the custom pose, so that the second account applies the custom pose to the second virtual character.

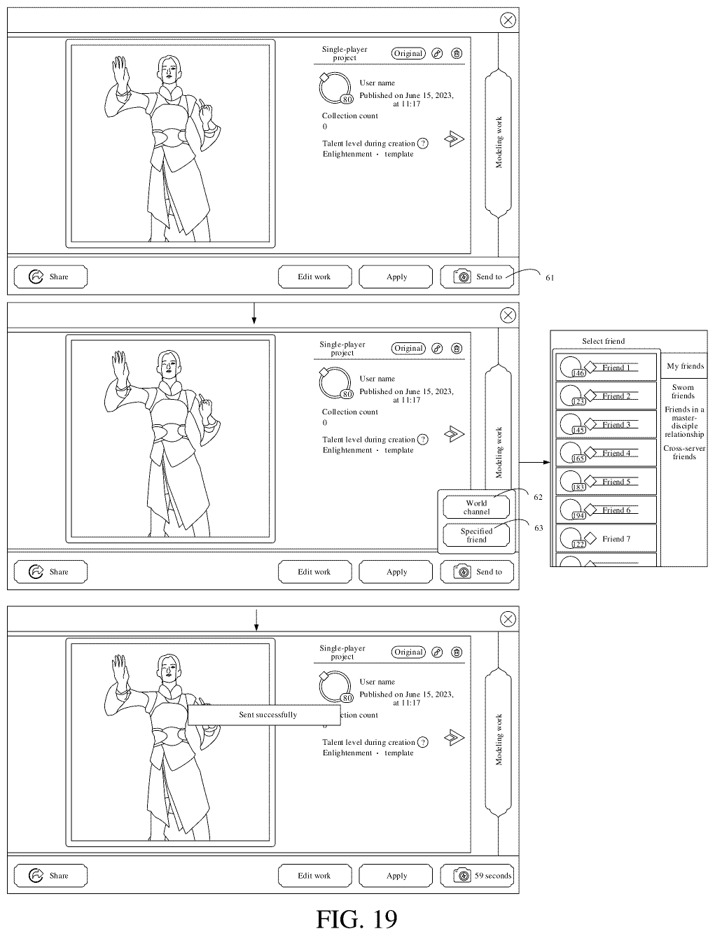

In some aspects, for example, as shown in FIG. 19, the introduction interface for the modeling work displays a “Send to” button 61. In response to a trigger operation on the “Send to” button 61, the terminal displays at least one of a world group option 62 or a specified friend option 63. In response to a trigger operation on the specified friend option 63, the terminal displays a plurality of friends of the first account on the network, for example, sworn friends, friends in a master-disciple relationship, and cross-server friends. In response to a trigger operation on the second account, the terminal shares the custom pose to the second account.

In some aspects, the sharing information displays information such as a name, a creator, creation time, and a preview of the modeling work. In response to a trigger operation on the sharing information, the terminal saves related data of the modeling work to a modeling catalog of the second account.

In some aspects, the client on which the second account is logged into obtains the absolute pose data of the custom pose, applies the absolute pose data to the second virtual character, and displays the second virtual character in the custom pose.

In some aspects, the client on which the second account is logged into obtains the relative pose data of the custom pose. The relative pose data of the custom pose is an offset value of the custom pose relative to the initial pose. The absolute pose data of the initial pose corresponding to the custom pose is obtained, and the relative pose data of the custom pose and the pose data of the initial pose are superimposed, to obtain the absolute pose data of the custom pose. The absolute pose data is applied to the second virtual character, to display the second virtual character in the custom pose.

Operation 395: Display, in response to an operation of sharing the custom pose to a specified group, sharing information of the custom pose in the specified group, so that a third account in the specified group applies the custom pose to a third virtual character.

The third virtual character is a virtual character controlled by the third account.

In some aspects, the first account and the third account belong to a same group, but do not necessarily have a friend relationship.

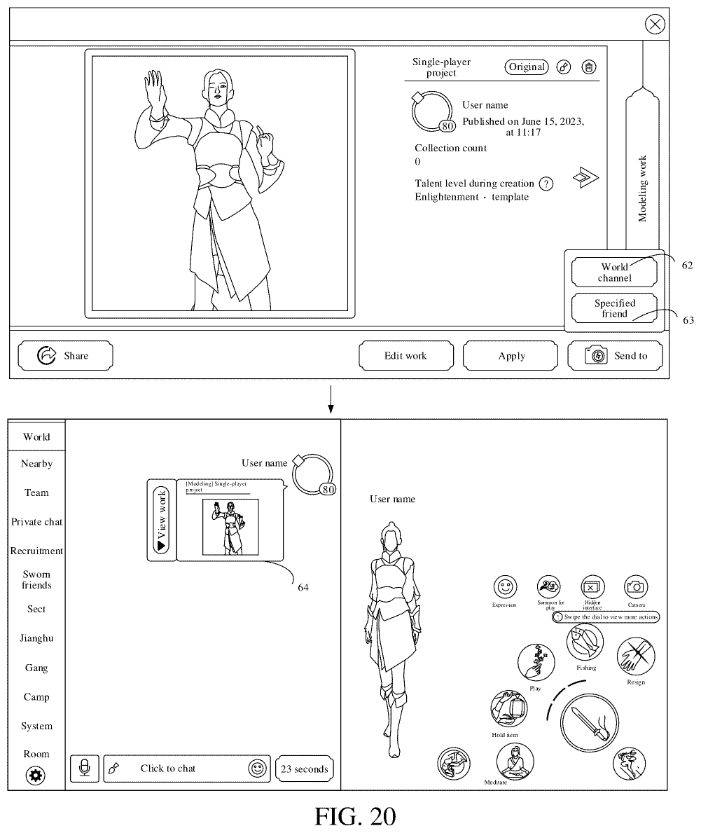

In some aspects, for example, as shown in FIG. 19 and FIG. 20, the introduction interface for the modeling work displays the “Send to” button 61. In response to the trigger operation on the “Send to” button 61, the terminal displays at least one of the world group option 62 or the specified friend option 63. In response to a trigger operation on the world group option 62, the custom pose is shared in a dialog box of the world group, and displayed as a sharing message 64. Another account in the world group views the preview of the modeling work through the sharing message 64, and clicks the sharing message 64 to apply the custom pose to the virtual character controlled by the another account.

In some aspects, the sharing information displays information such as a name, a creator, creation time, and a preview of the modeling work. In response to a trigger operation on the sharing information, the terminal saves related data of the modeling work to a modeling catalog of the third account.

In some aspects, the client on which the third account is logged into obtains the relative pose data of the custom pose. The relative pose data of the custom pose is an offset value of the custom pose relative to the initial pose. The absolute pose data of the initial pose corresponding to the custom pose is obtained, and the relative pose data of the custom pose and the pose data of the initial pose are superimposed, to obtain the absolute pose data of the custom pose. The absolute pose data is applied to the third virtual character, to display the third virtual character in the custom pose.

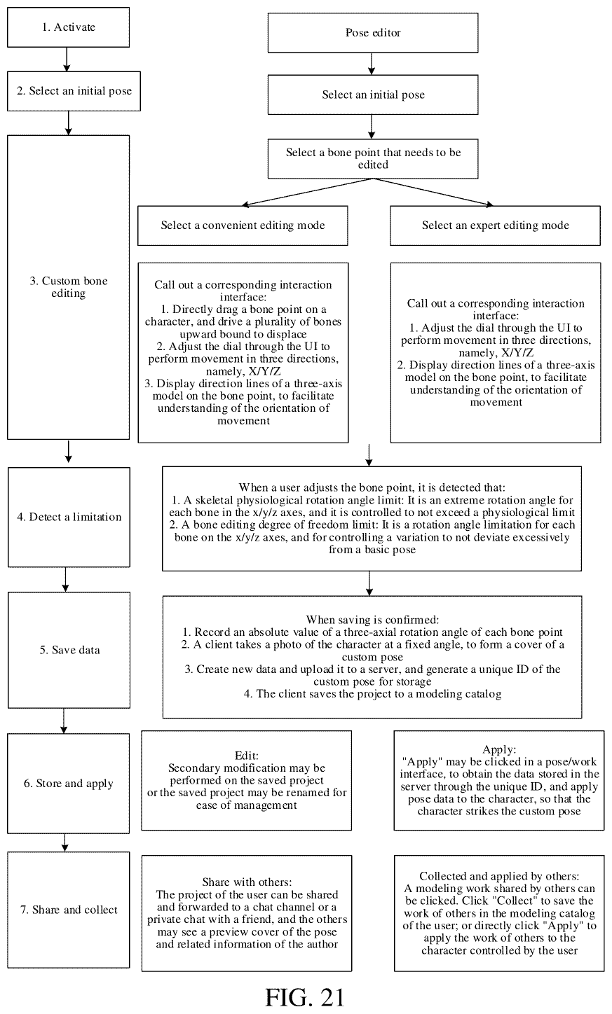

FIG. 21 is a flowchart of a pose editing method for a virtual character according to an illustrative aspect described herein. The method is performed by a computer device, and specifically is performed by a terminal. A client on which a first account is logged into is run in the terminal. The method includes at least some of the following operations:

### Operation 1: Activate

A user may open a modeling editor through an entry to the modeling editor in the client.

In some aspects, the modeling editor may be opened through Main interface-Menu-Entertainment hub-Modeling catalog-New single-player work. After secondary confirmation by the user, the modeling editor is transferred into an independent virtual environment, entering a modeling system. The independent virtual environment may be considered as a bitplane dedicated to modeling.

### Operation 2: Select an Initial Pose

A plurality of preset poses are provided after the modeling system is entered, and the plurality of preset poses are several different poses automatically configured by the modeling system. In this case, the user may select one of the preset poses as the initial pose.

### Operation 3: Custom Bone Editing

Since the system defaults to a joint mode upon entry, bone points of a character are displayed. The user may select bone points that need to be edited to change the pose of specific bones. The user may select a convenient IK editing mode to perform editing, or may select an expert rotation editing mode to perform editing.

When the convenient IK editing mode is selected, a corresponding interaction interface pops up, and the user may directly drag a target bone point on a model virtual character, and drive a plurality of bones upward bound to the target bone point to displace. In addition, the user may adjust the dial through the UI to perform movement in three directions, namely, X/Y/Z. Direction lines of a three-axis model are displayed on the target bone point, helping the user understand the orientation of movement.

When the expert rotation editing mode is selected, a corresponding interaction interface pops up, and the user may adjust the dial through the UI to perform movement in three directions, namely, X/Y/Z, on a bone corresponding to the target bone point. Direction lines of a three-dimensional spherical model are displayed on the target bone point, to help understand a radian position of rotation.

### Operation 4: Detect a Limitation

When the user adjusts the bones, the modeling system needs to detect at least one of the following limitations:
(1) A skeletal physiological rotation angle limit: It is an extreme rotation angle for each bone in the x/y/z axes. The extreme rotation angle is configured through a planner, and it is controlled to not exceed a physiological limit of the model virtual character.
(2) A bone editing degree of freedom rotation angle limit: It is an extreme rotation angle limitation for each bone on the x/y/z axes, for controlling a variation to not deviate excessively from the initial pose.

### Operation 5: Save Data

The user may save a custom pose. When saving is confirmed, the modeling system records an absolute value of a rotation angle of each bone point. In addition, the client takes a photo of the character at a fixed angle, to form a cover of a new pose. Then, new data is created and uploaded to the server, and a unique ID is generated for storage. The client saves the project to a portfolio UI of the user.

### Operation 6: Store and Apply

The user may perform secondary modification on the saved modeling work, or name the saved modeling work for ease of management. In addition, the user may click “Apply” in a pose/work interface, to obtain the data stored in the server through the unique ID, and apply pose data to a virtual character controlled by the user, so that the virtual character controlled by the user strikes the custom pose.

### Operation 7: Share and Collect

The user may forward and share the project to others, and the others see the preview cover of the modeling work and related information of the author. The user may further click on a modeling work shared by others to collect the modeling work, and add the modeling work shared by others to a modeling portfolio of the user. Alternatively, the user may directly click on the modeling work for application, to apply the modeling work shared by others to the virtual character controlled by the user.

The foregoing method aspects may be combined in pairs or multiple configurations based on understanding of a person skilled in the art, to form more aspects. Details are not described again in this application.

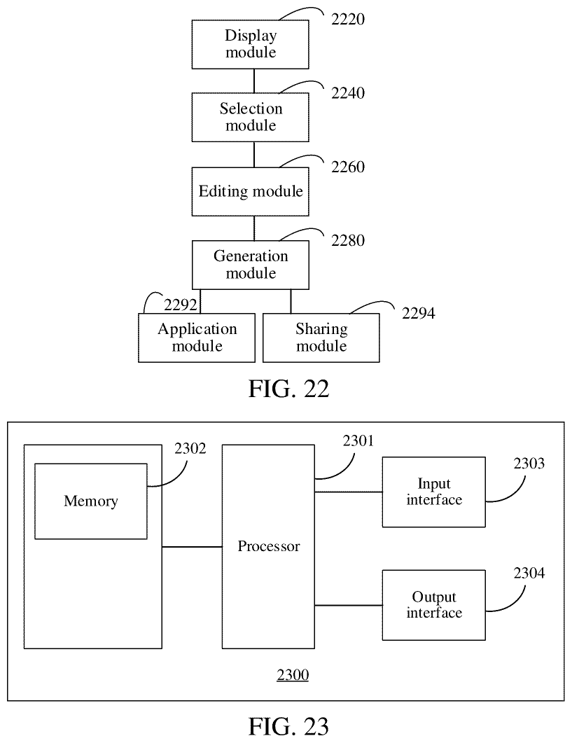

FIG. 22 is a schematic structural diagram of a pose editing apparatus for a virtual character according to an illustrative aspect described herein. The apparatus includes at least some of a display module 2220, a selection module 2240, and an editing module 2260.

The display module 2220 is configured to display a model virtual character located in a virtual environment and at least one candidate bone point.

The selection module 2240 is configured to display, in response to a selection operation on a target bone point of the at least one candidate bone point, an editing control configured to edit the target bone point.

The editing module 2260 is configured to rotate a bone corresponding to the target bone point in the virtual environment in response to an editing operation on the editing control.

In some aspects, the editing control includes: rotation controls respectively corresponding to three coordinate axes, and each rotation control is configured to implement rotational control corresponding to one of the three coordinate axes.

The editing module 2260 is configured to rotate, in response to a rotation operation on a first rotation control corresponding to a first coordinate axis, the bone corresponding to the target bone point around the first coordinate axis by using the target bone point as a rotation pivot.

The first coordinate axis is one of the three coordinate axes.

In some aspects, the editing module 2260 is configured to: rotate, in response to an operation of rotating the first rotation control corresponding to the first coordinate axis in a first rotation direction, the bone corresponding to the target bone point around the first coordinate axis in a clockwise direction by using the target bone point as the rotation pivot; and/or, rotate, in response to an operation of rotating the first rotation control corresponding to the first coordinate axis in a second rotation direction, the bone corresponding to the target bone point around the first coordinate axis in an anticlockwise direction by using the target bone point as the rotation pivot.

In some aspects, the first rotation control includes at least one of a button form or a ring dial form.

The display module 2220 is further configured to switch the first rotation control from the button form to the ring dial form in a case that a touch operation on the first rotation control is detected.

In some aspects, the display module 2220 is further configured to cancel display of a second rotation control and a third rotation control in a case that a touch operation on the first rotation control is detected.

The second rotation control is a rotation control corresponding to a second coordinate axis, the third rotation control is a rotation control corresponding to a third coordinate axis, and the second coordinate axis and the third coordinate axis are the other two coordinate axes in the three coordinate axes other than the first coordinate axis.

In some aspects, the display module 2220 is further configured to display, on the target bone point, a rotation indicator model corresponding to the three coordinate axes; and
cancel display of indicator elements on the rotation indicator model that correspond to the second coordinate axis and the third coordinate axis in a case that a touch operation on the first rotation control is detected,
the second coordinate axis and the third coordinate axis being the other two coordinate axes in the three coordinate axes other than the first coordinate axis.

In some aspects, the model virtual character is displayed based on a skeleton model, and the skeleton model includes at least one bone chain.

In some aspects, the editing module 2260 is configured to maintain, in a case that the bone corresponding to the target bone point is rotated to a restricted position, the bone corresponding to the target bone point in the restricted position,
the restricted position including at least one of a first restricted position or a second restricted position, the first restricted position is set based on a skeletal physiological angle limit of the model virtual character, and the second restricted position is set based on an editing degree of freedom limitation.

In some aspects, the display module 2220 is further configured to display at least one preset candidate pose option. The editing module 2260 is configured to set, in response to a selection operation on a first pose option of the at least one candidate pose option, an initial pose of the model virtual character in the virtual environment to a first pose corresponding to the first pose option.

In some aspects, the display module 2220 is further configured to display at least one generated pose option, the at least one generated pose option being a pose option corresponding to a modeling work obtained through user-defined editing. The editing module 2260 is configured to set, in response to a selection operation on a second pose option of the at least one generated pose option, an initial pose of the model virtual character in the virtual environment to a second pose corresponding to the second pose option.

In some aspects, the apparatus further includes a generation module 2280, configured to generate, based on a custom pose presented by the model virtual character, a modeling work configured for applying the custom pose to a virtual character controlled by at least one account.

In some aspects, the apparatus is logged in with a first account, and the apparatus further includes:
an application module 2292, configured to display, in response to an operation of applying the custom pose to a first virtual character, the first virtual character in the custom pose,
the first virtual character being a virtual character controlled by the first account.

In some aspects, the apparatus is logged in with a first account, and the apparatus further includes:
a sharing module 2294, configured to display, in response to an operation of sharing the custom pose to a second account, sharing information of the custom pose in a network space to which the second account has access permission, so that the second account applies the custom pose to a second virtual character,
the second virtual character being a virtual character controlled by the second account.

In some aspects, the apparatus is logged in with a first account, and the apparatus further includes:
a sharing module 2294, configured to display, in response to an operation of sharing the custom pose to a specified group, sharing information of the custom pose in the specified group, so that a third account in the specified group applies the custom pose to a third virtual character,
the third virtual character being a virtual character controlled by the third account.

For the apparatus provided in the foregoing aspects, during pose editing for the virtual character, only division of the foregoing function modules is described by using examples. In actual application, the foregoing functions may be allocated to and completed by different functional modules according to requirements. In other words, an internal structure of the device is divided into different function modules, to complete all or some of the functions described above. In addition, for details of a specific implementation process, refer to the method aspects, and details are not described herein again.

FIG. 23 is a structural block diagram of a computer device 2300 according to an illustrative aspect described herein.

Generally, the computer device 2300 includes a processor 2301 and a memory 2302.

The processor 2301 may include one or more processing cores, for example, a 4-core processor or an 8-core processor. The processor 2301 may be implemented by using at least one hardware form of digital signal processing (DSP), a field-programmable gate array (FPGA), and a programmable logic array (PLA). The processor 2301 may also include a main processor and a co-processor. The main processor is a processor configured to process data in an awake state, and is also referred to as a central processing unit (CPU). The co-processor is a low power consumption processor configured to process data in a standby state. In some aspects, the processor 2301 may be integrated with a graphics processing unit (GPU). The GPU is configured to render and draw contents that need to be displayed on a display screen. In some aspects, the processor 2301 may further include an artificial intelligence (AI) processor, which is configured to process a machine learning related computing operation.

The memory 2302 may include one or more computer-readable storage media. The computer-readable storage media may be non-transient. The memory 2302 may further include a high-speed random access memory and a non-volatile memory, such as one or more disk storage devices and flash storage devices. In some aspects, the non-transitory computer-readable storage medium in the memory 2302 is configured to store at least one instruction. The at least one instruction is executed by the processor 2301 to perform the pose editing method for a virtual character provided in the method aspects in this application.

In some aspects, the computer device 2300 may further include: an input interface 2303 and an output interface 2304. The processor 2301, the memory 2302, the input interface 2303, and the output interface 2304 may be connected through a bus or a signal cable. Each peripheral device may be connected to the input interface 2303 and the output interface 2304 through a bus, a signal cable, or a circuit board. The input interface 2303 and the output interface 2304 may be configured to connect at least one peripheral device related to input/output (I/O) to the processor 2301 and the memory 2302. In some aspects, the processor 2301, the memory 2302, the input interface 2303 and the output interface 2304 are integrated on the same chip or circuit board. In some other aspects, any one or two of the processor 2301, the memory 2302, the input interface 2303 and the output interface 2304 may be implemented on the single chip or the circuit board. This is not limited in this aspect described herein. A person skilled in the art may understand that the foregoing structure does not constitute a limitation on the computer device 2300, and the computer device may include more components or fewer components than those shown in the figure, or some components may be combined, or a different component deployment may be used.

In an illustrative aspect, a computer device is further provided. The computer device includes a processor and a memory, the memory having a computer program stored therein, the computer program being loaded and executed by the processor to implement the pose editing method for a virtual character described above.

In an illustrative aspect, a chip is further provided. The chip includes a programmable logic circuit and/or program instructions. A server or terminal with the chip installed is configured to implement the pose editing method for a virtual character described above.

In an illustrative aspect, a computer-readable storage medium is further provided. The storage medium has a computer program stored therein. When being executed by a processor, the at least one program is configured to implement the pose editing method for a virtual character described above. In some aspects, the computer-readable storage medium may be a read-only memory (ROM), a random access memory (RAM), a compact disc read-only memory (CD-ROM), a magnetic tape, a floppy disk, an optical data storage device, or the like.

In an illustrative aspect, a computer program product is further provided. The computer program product includes a computer program. The computer program is stored in a computer-readable storage medium. A processor reads the computer program from the computer-readable storage medium and executes the computer program, to implement the pose editing method for a virtual character described above.

What is claimed is:

1. A computer implemented method comprising:
displaying a model virtual character located in a virtual environment and at least one candidate bone point;
displaying, responsive to a selection operation on a target bone point of the at least one candidate bone point, an editing control configured to edit the target bone point; and
rotating a bone corresponding to the target bone point in the virtual environment responsive to an editing operation on the editing control.

2. The method according to claim 1, wherein the editing control comprises: three rotation controls respectively corresponding to three coordinate axes, wherein each rotation control is configured to implement rotational control corresponding to one of the three coordinate axes; and
the rotating the bone comprises:
rotating, in response to a rotation operation received via a first rotation control corresponding to a first coordinate axis of the three coordinate axes, the bone corresponding to the target bone point around the first coordinate axis by using the target bone point as a rotation pivot.

3. The method according to claim 2, wherein the rotating the bone corresponding to the target bone point comprises at least one of the following:
rotating, in response to an operation of rotating the first rotation control corresponding to the first coordinate axis in a first rotation direction, the bone corresponding to the target bone point around the first coordinate axis in a clockwise direction by using the target bone point as the rotation pivot; and
rotating, in response to an operation of rotating the first rotation control corresponding to the first coordinate axis in a second rotation direction, the bone corresponding to the target bone point around the first coordinate axis in an anticlockwise direction by using the target bone point as the rotation pivot.

4. The method according to claim 2, wherein the first rotation control comprises at least one of a button form or a ring dial form; and the method further comprises:
switching the first rotation control from the button form to the ring dial form in a case that a touch operation on the first rotation control is detected.

5. The method according to claim 2, further comprising:
detecting a touch operation on the first rotation control is detected;
cancelling, responsive to the detecting, display of a second rotation control and a third rotation control, wherein the second rotation control corresponds to a second coordinate axis of the three coordinate axes, and the third rotation control corresponds to a third coordinate axis of the three coordinate axes.

6. The method according to claim 2, further comprising:
displaying, on the target bone point, a rotation indicator model corresponding to the three coordinate axes; and
cancelling display of indicator elements on the rotation indicator model that correspond to the second coordinate axis and the third coordinate axis when a touch operation on the first rotation control is detected,
the second coordinate axis and the third coordinate axis being the other two coordinate axes in the three coordinate axes other than the first coordinate axis.

7. The method according to claim 1, further comprising:
maintaining, when the bone corresponding to the target bone point is rotated a predetermined maximum amount, the bone corresponding to the target bone point in the predetermined maximum amount,
the predetermined maximum amount comprising at least one of a first predetermined component or a second predetermined component, the first predetermined component being based on a skeletal physiological angle limit of the model virtual character, and the second predetermined component being based on an editing degree of freedom limitation.

8. The method according to claim 1, further comprising:
displaying at least one preset pose option; and
setting, in response to a selection operation on a first pose option of the at least one preset pose option, an initial pose of the model virtual character in the virtual environment to a first pose corresponding to the first pose option.

9. The method according to claim 1, further comprising:
displaying at least one generated pose option, the at least one generated pose option being a pose option corresponding to a custom pose obtained through user-defined editing; and
setting, in response to a selection operation on a second pose option of the at least one generated pose option, an initial pose of the model virtual character in the virtual environment to a second pose corresponding to the second pose option.

10. The method according to claim 1, further comprising:
generating, based on a custom pose presented by the model virtual character, pose data configured for applying the custom pose to a virtual character controlled by at least one account.

11. The method according to claim 10, wherein the method is performed by a client logged into a first account, and the method further comprises:
displaying, in response to an operation of applying the custom pose to a first virtual character, the first virtual character in the custom pose,
the first virtual character being a virtual character controlled by the first account.

12. The method according to claim 10, wherein the method is performed by a client that logs into a first account, and the method further comprises:
displaying, in response to input instructing sharing the custom pose to a second account, sharing information of the custom pose in a network space to which the second account has access permission, so that the second account can apply the custom pose to a second virtual character,
the second virtual character being a virtual character controlled by the second account.

13. The method according to claim 10, wherein the method is performed by a client that logs into a first account, and the method further comprises:
displaying, in response to input instructing sharing the custom pose to a specified group, sharing information of the custom pose in the specified group, so that a third account in the specified group can apply the custom pose to a third virtual character,
the second virtual character being a virtual character controlled by the second account, and the third virtual character being a virtual character controlled by the third account.

14. The method of claim 1, wherein the at least one candidate bone point comprises a plurality of candidate bone points.

15. The method of claim 14, where in the plurality of candidate bone points comprises a neck, a shoulder, an elbow, a hand, a hip, a knee, and an ankle.

16. One or more non-transitory computer readable media comprising computer readable instructions which, when executed by a processor, configure a data processing system to perform:
displaying a model virtual character located in a virtual environment and at least one candidate bone point;
displaying, responsive to a selection operation on a target bone point of the at least one candidate bone point, an editing control configured to edit the target bone point, wherein the editing control comprises three rotation controls respectively corresponding to three coordinate axes, wherein each rotation control is configured to implement rotational control corresponding to a corresponding one of the three coordinate axes; and
rotating a bone corresponding to the target bone point around a first coordinate axis using the target bone point as a rotation pivot, responsive to a rotation operation received via a first rotation control of the three rotation controls.

17. The computer readable medium of claim 16, wherein the computer readable instructions, when executed, further configure the data processing system to perform:
displaying, on the target bone point, a rotation indicator model corresponding to the three coordinate axes; and
cancelling display of indicator elements on the rotation indicator model that correspond to the second coordinate axis and the third coordinate axis when a touch operation on the first rotation control is detected, the second coordinate axis and the third coordinate axis being the other two coordinate axes in the three coordinate axes other than the first coordinate axis.

18. The computer readable medium of claim 16, wherein the computer readable instructions, when executed, further configure the data processing system to perform:
maintaining, when the bone corresponding to the target bone point is rotated a predetermined maximum amount, the bone corresponding to the target bone point in the predetermined maximum amount, wherein the predetermined maximum amount is comprised of at least one of a first predetermined component or a second predetermined component, the first predetermined component being based on a skeletal physiological angle limit of the model virtual character, and the second predetermined component being based on an editing degree of freedom limitation.

19. The computer readable medium of claim 16, wherein the computer readable instructions, when executed, further configure the data processing system to generate, based on a custom pose presented by the model virtual character, pose data configured for applying the custom pose to a virtual character controlled by at least one account.

20. A system, comprising:
a processor; and
memory storing computer readable instructions which, when executed by the processor, configure the system to perform:
displaying a model virtual character located in a virtual environment and at least one candidate bone point;
displaying, responsive to a selection operation on a target bone point of the at least one candidate bone point, an editing control configured to edit the target bone point, wherein the editing control comprises three rotation controls respectively corresponding to three coordinate axes, wherein each rotation control is configured to implement rotational control corresponding to a corresponding one of the three coordinate axes;
rotating a bone corresponding to the target bone point around a first coordinate axis using the target bone point as a rotation pivot, responsive to a rotation operation received via a first rotation control of the three rotation controls;
maintaining, when the bone corresponding to the target bone point is rotated a predetermined maximum amount, the bone corresponding to the target bone point in the predetermined maximum amount, wherein the predetermined maximum amount is comprised of at least one of a first predetermined component or a second predetermined component, the first predetermined component being based on a skeletal physiological angle limit of the model virtual character, and the second predetermined component being based on an editing degree of freedom limitation; and
generating, based on a custom pose presented by the model virtual character, pose data configured for applying the custom pose to a virtual character controlled by at least one account.
